(19) United States
(12) Patent Application Publication
(10) Pub. No.: US 2026/0104669 A1
(43) Pub. Date: Apr. 16, 2026

(54) IMAGE FORMING APPARATUS

(71) Applicant: BROTHER KOGYO KABUSHIKI KAISHA, Nagoya (JP)

(72) Inventors: Masakazu Okawa, Nagoya (JP); Takuya Tsuji, Nagoya (JP)

(73) Assignee: BROTHER KOGYO KABUSHIKI KAISHA, Nagoya (JP)

(21) Appl. No.: 19/346,719

(22) Filed: Oct. 1, 2025

(30) Foreign Application Priority Data
Oct. 10, 2024 (JP) 2024-178444

(51) Int. Cl. G03G 21/16; G03G 15/00; G03G 15/20

(52) U.S. Cl. CPC G03G 21/1633; G03G 15/2017; G03G 15/2064; G03G 15/80; G03G 21/1647; G03G 21/1652; G03G 2221/1654; G03G 2221/169

(57) ABSTRACT

An image forming apparatus includes a main body including a main housing, a cover, and a fixing device installable into and removable from the main housing through an opening in the main housing. The cover is movable between a closed position and an open position to cover and uncover the opening. The main body has a first exterior surface, a second exterior surface, and a curved first corner portion connecting the exterior surfaces. The cover forms at least a part of the first exterior surface and the first corner portion. The fixing device comprises an engagement portion located at one end thereof on one side in a widthwise direction. The first corner portion overlaps the engagement portion as viewed in an installation-removable direction in a state where the fixing device is installed in the main housing and the cover is located in the closed position.

### REFERENCE TO RELATED APPLICATIONS

This application claims priority from Japanese Patent Application No. 2024-178444 filed on October 10, 2024. The entire contents of the priority application are incorporated herein by reference.

### BACKGROUND ART

An image forming apparatus known in the art includes a main housing and a fixing device installable into and removable from the main housing. The main housing has a rear cover that covers and uncovers an opening in the main housing. In such an image forming apparatus, the fixing device is installable into and removable from the main housing through the opening when the opening is uncovered.

### SUMMARY

The size of image forming apparatuses that are configured to allow fixing devices to be installed therein and removed therefrom tends to increase. It would be desirable to restrain the size of such image forming apparatuses from increasing.

In one aspect, an image forming apparatus disclosed herein includes a main body and a fixing device.

The main body includes a main housing and a cover.

The main housing has an opening in a first side surface thereof.

The cover is movable between a closed position in which the cover is placed over at least a part of the first side surface to cover the opening, and an open position in which the opening is uncovered.

The fixing device is installable into and removable from the main housing through the opening in a state where the cover is located in the open position. The fixing device is installable into the main housing from one side toward another side in an installation-removal direction and removable from the main housing from the another side toward the one side in the installation-removable direction.

The main body has a first exterior surface, a second exterior surface, and a first corner portion in a state where the cover is located in the closed position.

The first exterior surface is a side surface located on a same side of the main housing as a side on which the first side surface is located.

The second exterior surface is a side surface located on one side in a widthwise direction perpendicular to the installation-removal direction and to an up-down direction with respect to the first exterior surface.

The first corner portion is a curved corner portion connecting the first exterior surface and the second exterior surface.

The cover located in the closed position forms at least a part of the first exterior surface and at least a part of the first corner portion.

The fixing device comprises an engagement portion located at one end thereof on the one side in the widthwise direction and engaged with the main housing in a state where the fixing device is installed in the main housing.

The first corner portion overlaps the engagement portion as viewed in the installation-removable direction in a state where the fixing device is installed in the main housing and the cover is located in the closed position.

Since the first corner portion overlaps the engagement portion as viewed in the installation-removable direction in the state where the fixing device is installed in the main housing and the cover is located in the closed position, the image forming apparatus that allows the fixing device to be installed therein and removed therefrom can be restrained from increasing in size.

The cover may include a plurality of cover ribs.

The plurality of cover ribs protrude from an inner surface of the first corner portion toward the another side in the installation-removal direction and contact the main housing in the state where the cover is located in the closed position.

The cover ribs are aligned in the up-down direction.

Since the cover has a plurality of cover ribs protruding from the inner surface of the first corner portion, the first corner portion can be reinforced.

The main housing may include a rib contacting portion.

The rib contacting portion is contacted by the plurality of cover ribs in the state where the cover is located in the closed position. The rib contacting portion extends in the up-down direction.

Since the main housing includes the rib contacting portion contacted by the plurality of cover ribs and extending in the up-down direction, a load received from the cover ribs can be distributed therethrough.

The main housing may include a first side cover that forms at least a part of the second exterior surface, and the rib contacting portion may be formed on the first side cover.

The main housing may include a plurality of main body ribs.

The plurality of main body ribs protrude from the rib contacting portion toward the another side in the installation-removal direction. The main body ribs are aligned in the up-down direction.

Since the main housing includes a plurality of main body ribs protruding from the rib contacting portion, the rib contacting portion can be reinforced.

At least one of the plurality of cover ribs may overlap a corresponding one of the plurality of main body ribs as viewed in the installation-removal direction in the state where the cover is located in the closed position.

Since at least one of the plurality of cover ribs overlap a corresponding one of the plurality of main body ribs as viewed in the installation-removal direction in the state where the cover is located in the closed position, the portion of the rib contacting portion that receives the load from the cover rib can be reinforced.

The plurality of cover ribs may include a plurality of first cover ribs arranged next to each other in the up-down direction and a plurality of second cover ribs arranged next to each other in the up-down direction. A distance between the first cover ribs arranged next to each other may be smaller than a distance between the second cover ribs arranged next to each other.

Since the distance between the first cover ribs arranged next to each other is smaller than the distance between the second cover ribs arranged next to each other, the portion of the cover in which the first cover ribs are formed can be reinforced.

At least one of the plurality of first cover ribs may overlap a corresponding one of the plurality of main body ribs as viewed in the installation-removal direction in the state where the cover is located in the closed position.

Since at least one of the plurality of first cover ribs overlap a corresponding one of the plurality of main body ribs as viewed in the installation-removal direction in the state where the cover is located in the closed position, the portion of the rib contacting portion that receives the load from the first cover ribs can be reinforced by the main body ribs. Thus, the portion of the cover in which the cover ribs are formed can further be reinforced.

The fixing device may have a fixing handle.

The fixing handle is graspable when the fixing device is installed into and removed from the main housing. The fixing handle is located at the one end of the fixing device on the one side in the widthwise direction.

The cover may cover the fixing handle from the one side in the widthwise direction in the state where the fixing device is installed in the main housing and the cover is located in the closed position.

Since the cover covers the fixing handle from the one side in the widthwise direction in the state where the fixing device is installed in the main housing and the cover is located in the closed position, the fixing handle can be exposed when the cover is opened. In this way, it is easier to visually identify and grasp the fixing handle.

The fixing device may have a fixing handle, and the cover may have a recess.

The fixing handle is graspable when the fixing device is installed into and removed from the main housing. The fixing handle protrudes toward the one side in the installation-removal direction.

The recess receives the fixing handle in the state where the fixing device is installed in the main housing and the cover is located in the closed position.

Since the cover has the recess that receives the fixing handle in the state where the fixing device is installed in the main housing and the cover is located in the closed position, the fixing handle protrudes toward the one side in the installation-removal direction when the cover is opened and the fixing handle is thereby easily graspable.

The cover may include a first portion in which the recess is formed and a second portion located below the first portion. The first portion may protrude further outward, than the second portion, toward the one side in the installation-removal direction in the state where the cover is located in the closed position.

The cover may have an asymmetrical shape.

The main body may further include a third exterior surface that is a side surface located on another side in the widthwise direction with respect to the first exterior surface and a curved second corner portion connecting the first exterior surface and the third exterior surface. The main housing may form the second corner portion.

The main housing may include a second side cover forming at least a part of the third exterior surface and the second corner portion.

The main body may include a first main body connector, and the second corner portion may have a recess.

A cable is electrically connected to the first main body connector.

The recess is recessed toward the another side in the installation-removal direction. The first main body connector is located in the recess.

Since the first main body connector is located in the recess of the second corner portion formed by the second side cover, and the second side cover (main housing) does not move unlike the cover, the first main body connector and cables connected thereto can be appropriately protected.

The cover may have a cover handle graspable when opening and closing the cover. The cover handle may be located at a central portion of the cover in the widthwise direction.

The cover handle may protrude toward the one side in the installation-removal direction in the state where the cover is located in the closed position.

The main body may include a second main body connector to which the fixing device is electrically connected. The engagement portion may be a fixing connector connected to the second main body connector in the state where the fixing device is installed in the main housing.

In another aspect, an image forming apparatus disclosed herein includes a main housing, a cover, and a fixing device.

The main housing has an opening in a side surface thereof.

The cover is movable between a closed position in which the cover is placed over at least a part of the side surface to cover the opening, and an open position in which the opening is uncovered.

The fixing device is installable into and removable from the main housing through the opening in a state where the cover is located in the open position. The fixing device is installable into the main housing from one side toward another side in an installation-removal direction and removable from the main housing from the another side toward the one side in the installation-removable direction.

The cover overlaps the fixing device as viewed in the installation-removal direction and overlaps the fixing device as viewed in a widthwise direction perpendicular to the installation-removal direction and to an up-down direction, in a state where the fixing device is installed in the main housing and the cover is located in the closed position.

Since the cover overlaps the fixing device as viewed in the installation-removal direction and overlaps the fixing device as viewed in the widthwise direction in a state where the fixing device is installed in the main housing and the cover is located in the closed position, the image forming apparatus that allows the fixing device to be installed therein and removed therefrom can be restrained from increasing in size.

The fixing device may have a fixing handle.

The fixing handle is graspable when the fixing device is installed into and removed from the main housing. The fixing handle is located at one end of the fixing device on one side in the widthwise direction.

The cover may cover the fixing handle from the one side in the widthwise direction in the state where the fixing device is installed in the main housing and the cover is located in the closed position.

Since the cover covers the fixing handle, located at the one end of the fixing device on the one side in the widthwise direction, from the one side in the widthwise direction in the state where the fixing device is installed in the main housing and the cover is located in the closed position, the fixing handle can be exposed when the cover is opened. In this way, it is easier to visually identify and grasp the fixing handle.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is a cross-sectional view of an image forming apparatus.

FIG. 2 is a perspective view of a fixing device and a main body of the image forming apparatus with a rear cover located in an open position.

FIG. 3 is a perspective view of a fixing-connector side of the fixing device.

FIG. 4 is a perspective view of the image forming apparatus.

FIG. 5 is a perspective view of the image forming apparatus with the rear cover in the open position.

FIG. 6 is an illustration of the image forming apparatus as viewed from one side in an installation-removal direction.

FIG. 7 is an enlarged cross-sectional view of the image forming apparatus as viewed in a widthwise direction showing the vicinity of a fixing handle.

FIG. 8 is an enlarged perspective view showing the image forming apparatus with the rear cover in an open position.

FIG. 9 is a cross-sectional perspective view of the image forming apparatus as viewed in the widthwise direction showing the vicinity of cover ribs.

FIG. 10 is an enlarged cross-sectional view of the image forming apparatus as viewed in the widthwise direction showing the vicinity of the cover ribs.

FIG. 11 is a perspective view showing the image forming apparatus in a packaged state.

FIG. 12 is an enlarged cross-sectional view showing the vicinity of a first corner portion of the image forming apparatus as viewed from above.

FIG. 13 is a perspective rear view of a main housing of the main body as viewed diagonally from below.

FIG. 14 is an enlarged perspective view of the vicinity of a fixing piece of a first side cover.

FIG. 15A is an enlarged view of portion A of FIG. 13.

FIG. 15B is a cross-sectional view of the vicinity of a first engagement piece as viewed from the one side in the installation-removal direction.

FIG. 16 is a perspective front view of the main housing as viewed diagonally from below.

FIG. 17A is a perspective view showing the vicinity of a projection of a second side cover.

FIG. 17B is a sectional view taken along line B-B of FIG. 17A.

### DESCRIPTION

An embodiment of the present disclosure will be described in detail referring to the drawings where appropriate.

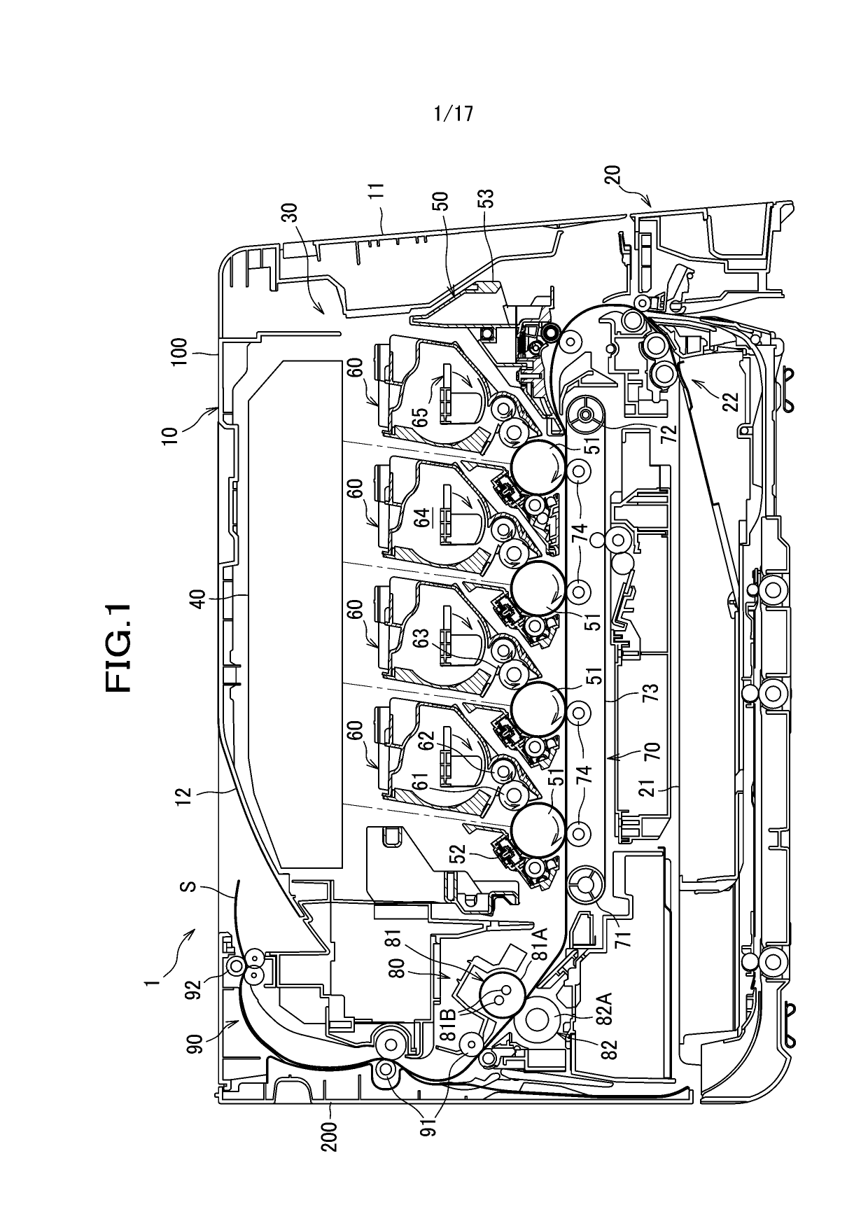

As shown in FIG. 1, an image forming apparatus 1 comprises a main body 10, a sheet feeder unit 20, a process unit 30, a fixing device 80, and a sheet ejection unit 90.

The main body 10 comprises a main housing 100, a front cover 11, and a rear cover 200 as an example of a cover. The main housing 100 comprises an output tray 12 that supports sheets S on which images are formed. The front cover 11 covers and uncovers an opening formed on the front side of the main housing 100. The rear cover 200 covers and uncovers an opening formed on the rear side of the main housing 100.

The sheet feeder unit 20 comprises a sheet tray 21 and a feeding mechanism 22. The sheet tray 21 contains sheets S of paper or the like. The feeding mechanism 22 feeds the sheets S in the sheet tray 21 to the process unit 30.

The process unit 30 transfers a toner image onto each sheet S. The process unit 30 comprises an exposure device 40, a drum cartridge 50, a plurality of toner cartridges 60, and a transfer unit 70.

The exposure device 40 is located above the drum cartridge 50. The exposure device 40 emits light beams to expose surfaces of photosensitive drums 51.

The drum cartridge 50 is located between the sheet tray 21 and the exposure device 40. The drum cartridge 50 is installable into and removable from the main housing 100 through the opening of the main housing 100, which is uncovered by opening the front cover 11. The drum cartridge 50 comprises a plurality of photosensitive drums 51, a plurality of chargers 52 each corresponding to one of the photosensitive drums 51, and a drum frame 53.

The drum frame 53 supports the photosensitive drums 51 and the chargers 52. The photosensitive drums 51 are rotatable relative to the drum frame 53. The drum frame 53 is movably supported by the main housing 100. The toner cartridges 60 are installable onto and removable from the drum frame 53.

The plurality of toner cartridges 60 each contains toner of a different color. Each toner cartridge 60 comprises a development roller 61, a supply roller 62, a doctor blade 63, a toner containing unit 64 that contains toner, and an agitator 65.

The agitator 65 agitates toner in the toner containing unit 64. The agitator 65 supplies toner to the supply roller 62. The supply roller 62 supplies toner to the development roller 61. The doctor blade 63 adjusts the thickness of toner on the development roller 61 to a uniform thickness.

The transfer unit 70 is located between the sheet tray 21 and the drum cartridge 50. The transfer unit 70 comprises a drive roller 71, a follower roller 72, a conveyor belt 73, and a plurality of transfer rollers 74. The conveyor belt 73 is an endless belt for conveying the sheet S. The drive roller 71 and the follower roller 72 cause the conveyor belt 73 to rotate. The transfer rollers 74 face an inner surface of the conveyor belt 73. The conveyor belt 73 is sandwiched between the transfer rollers 74 and the photosensitive drums 51.

The fixing device 80 comprises a heating member 81 and a pressure member 82. The heating member 81 heats the sheet S. The heating member 81 comprises a heating roller 81A and two heaters 81B. The pressure member 82 nips the sheet S in combination with the heating member 81. The pressure member 82 comprises a pressure roller 82A.

The heating roller 81A and the pressure roller 82A are rotatable. In this embodiment, the heating roller 81A receives a driving force from a drive source and rotates. The pressure roller 82A is driven by the heating roller 81A and rotates.

The chargers 52 charge the corresponding surfaces of the photosensitive drums 51. The exposure device 40 exposes the surfaces of the photosensitive drums 51. Electrostatic latent images are thereby formed on the photosensitive drums 51. The development rollers 61 supply toner to the corresponding photosensitive drums 51. Toner images are thereby formed on the photosensitive drums 51.

The sheet feeder unit 20 feeds the sheet S through between the photosensitive drums 51 and the transfer rollers 74. The toner images on the photosensitive drums 51 are transferred onto the sheet S. The sheet S on which the toner images are transferred is conveyed through between the heating roller 81A and the pressure roller 82A. The fixing device 80 thereby fixes the toner images on the sheet S.

The sheet ejection unit 90 comprises conveyor rollers 91 and an ejection roller 92. The conveyor rollers 91 convey the sheet S to the ejection roller 92. The ejection roller 92 ejects the sheet S onto the output tray 12.

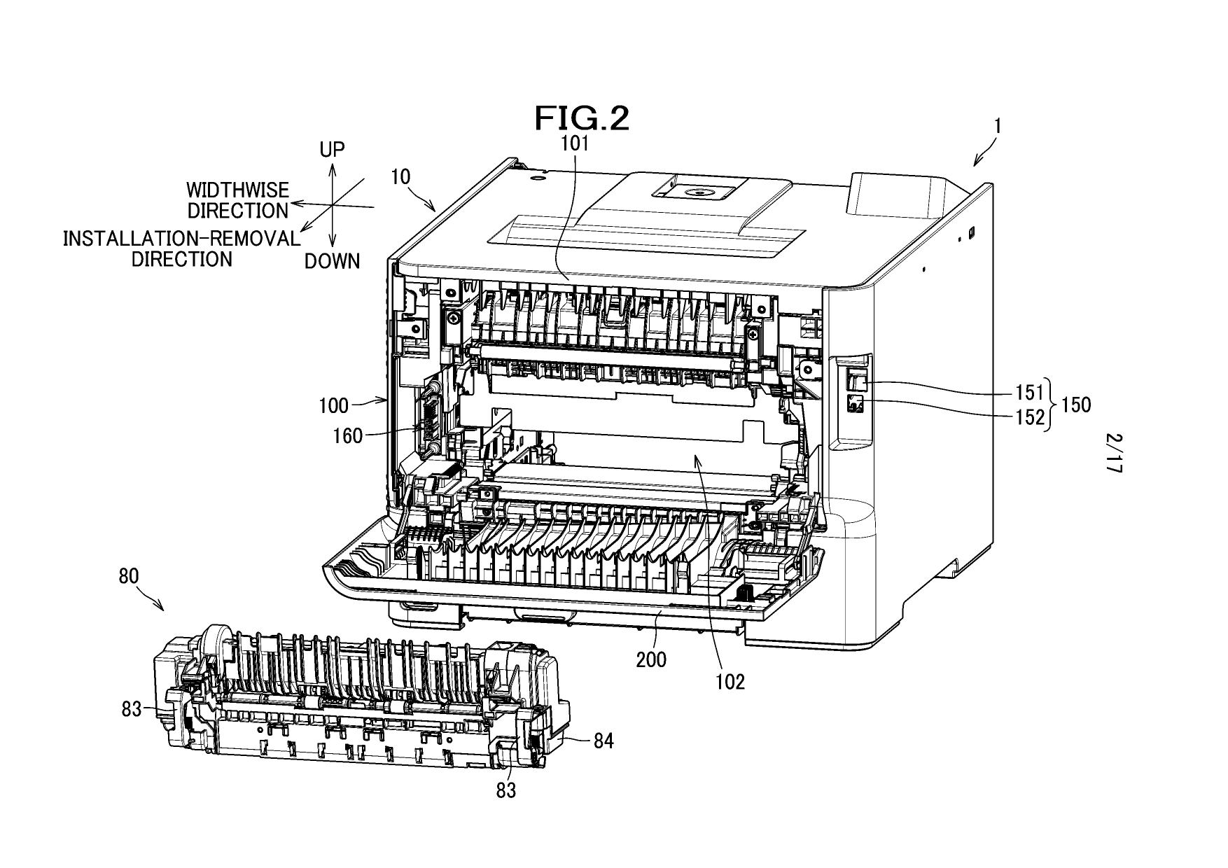

As shown in FIG. 2, the fixing device 80 is installable into and removable from the main housing 100. In more detail, the fixing device 80 is installable into and removable from the main housing 100 through an opening 102 of the main housing, which is uncovered when the rear cover 200 is opened. In the following description, directions will be described using an installation-removal direction and a widthwise direction shown in FIG. 2.

The installation-removal direction is a direction along a direction in which the fixing device 80 is moved when the fixing device 80 is installed into or removed from the main housing 100. In this embodiment, the installation-removal direction corresponds to the front-rear direction of the image forming apparatus 1. One side in the installation-removal direction corresponds to the rear side of the image forming apparatus 1, and the other side in the installation-removal direction corresponds to the front side of the image forming apparatus 1. In the drawings referred to in the specification, the arrows showing the installation-removal direction point to the one side in the installation-removal direction.

The widthwise direction is a direction perpendicular to the installation-removal direction and to the up-down direction of the image forming apparatus 1. In this embodiment, the widthwise direction corresponds to the lateral direction of the image forming apparatus 1. One side in the widthwise direction corresponds to the right side of the image forming apparatus 1, and the other side in the widthwise direction corresponds to the left side of the image forming apparatus 1. In the drawings referred to in the specification, the arrows showing the widthwise direction point to the one side in the widthwise direction.

The main body 10 comprises a first main body connector 150 and a second main body connector 160. The first main body connector 150 is a connector to which cables are electrically connected. The first main body connector 150 is exposed to the outside of the main housing 100. In one example, the first main body connector 150 includes a Universal Serial Bus (USB) connector 151 and a Local Area Network (LAN) connector 152. The USB connector 151 is a connector to which a USB cable is electrically connected. The LAN connector 152 is a connector to which a LAN cable is electrically connected.

The second main body connector 160 is a connector to which the fixing device 80 is electrically connected. The second main body connector 160 is disposed in the main housing 100. The second main body connector 160 is exposed through the opening 102 when the rear cover 200 is opened. The second main body connector 160 is a floating connector held by the main housing 100 in a manner that allows the second main body connector 160 to move relative to the main housing 100.

The fixing device 80 comprises fixing handles 83. The fixing handles 83 are graspable when the fixing device 80 is installed into and removed from the main housing 100. The fixing handles 83 protrude from a frame 84 of the fixing device 80 toward the one side in the installation-removal direction. In this embodiment, the fixing handles 83 protrude rearward. One of the fixing handles 83 is formed on one end portion of the fixing device 80 and the other of the fixing handles 83 is formed on the other end portion of the fixing device 80 in the widthwise direction.

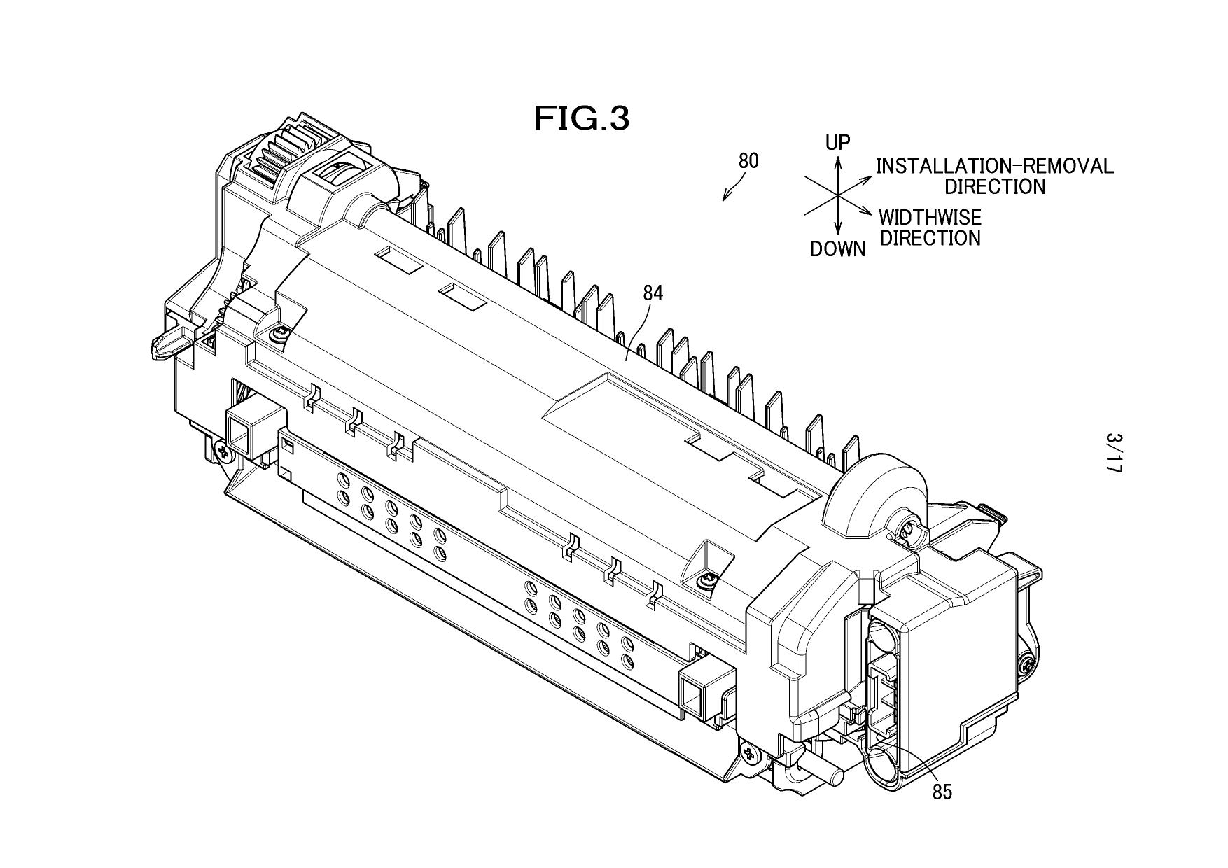

As shown in FIG. 3, the fixing device 80 comprises a fixing connector 85 as an example of an engagement portion on the one end portion thereof in the widthwise direction. In other words, the “engagement portion” is the fixing connector 85 in this embodiment. The fixing connector 85 is engaged with the main housing 100 in a state where the fixing device 80 is installed in the main housing 100. In more detail, the fixing connector 85 is connected to the second main body connector 160 (see FIG. 2) in the state where the fixing device 80 is installed in the main housing 100. In a state where the fixing connector 85 is connected to the second main body connector 160, electricity can, for example, be supplied to the heaters 81B of the heating member 81 (see FIG. 1).

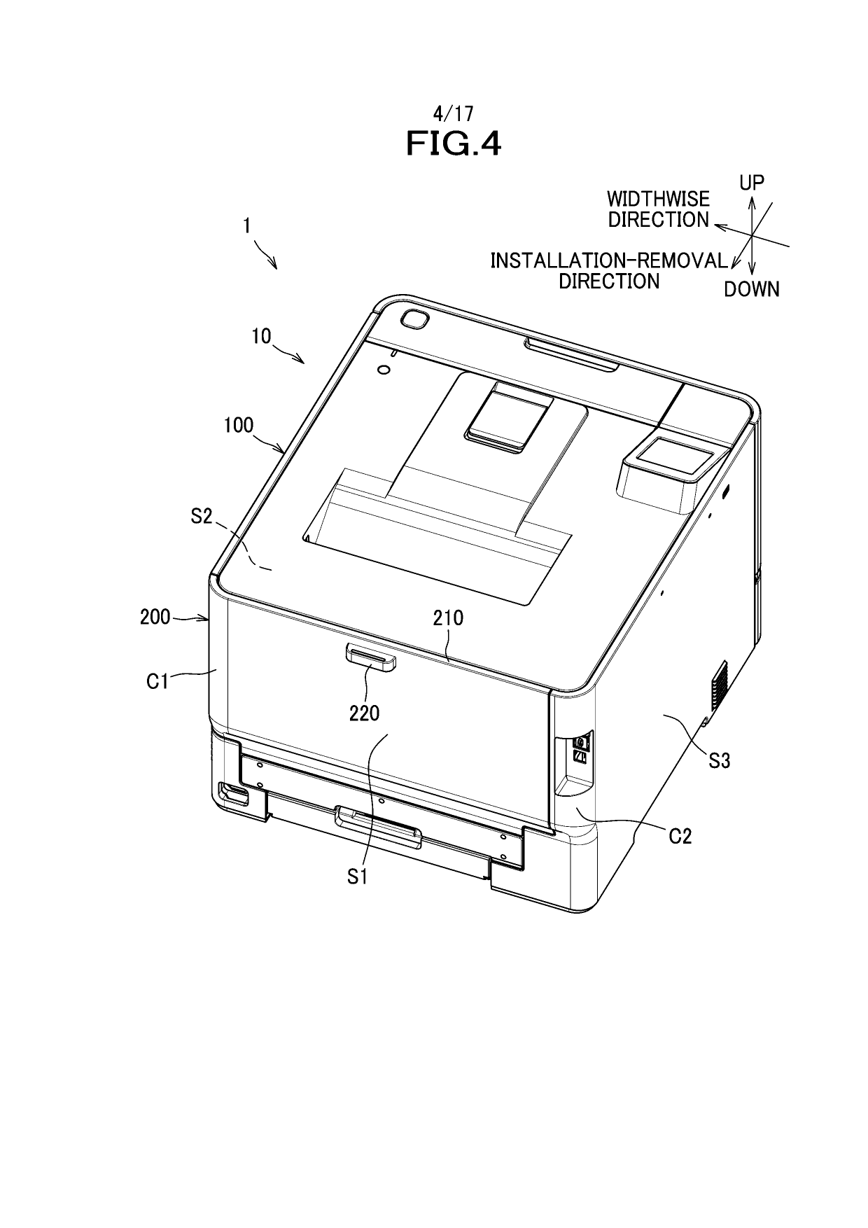

As shown in FIG. 4, the main body 10 comprises a first exterior surface S1, a second exterior surface S2, a third exterior surface S3, a first corner portion C1, and a second corner portion C2 in a state where the rear cover 200 is located in a closed position which will be described below.

The first exterior surface S1 is a side surface of the main body 10 on the one side in the installation-removal direction. In this embodiment, the first exterior surface S1 is the rear side surface of the main body 10.

The second exterior surface S2 is a side surface of the main body 10 located on the one side in the widthwise direction with respect to the first exterior surface S1. In this embodiment, the second exterior surface S2 is the right side surface of the main body 10. The third exterior surface S3 is a side surface of the main body 10 located on the other side in the widthwise direction with respect to the first exterior surface S1. In this embodiment, the third exterior surface S3 is the left side surface of the main body 10.

The first corner portion C1 is formed to connect the first exterior surface S1 and the second exterior surface S2. The second corner portion C2 is formed to connect the first exterior surface S1 and the third exterior surface S3. The first corner portion C1 and the second corner portion C2 are corner portions of the main body 10 that are curved and protrude outward toward the outside of the main body 10. In other words, the first corner portion C1 and the second corner portion C2 are rounded corner portions. The first corner portion C1 and the second corner portion C2 extend in the up-down direction.

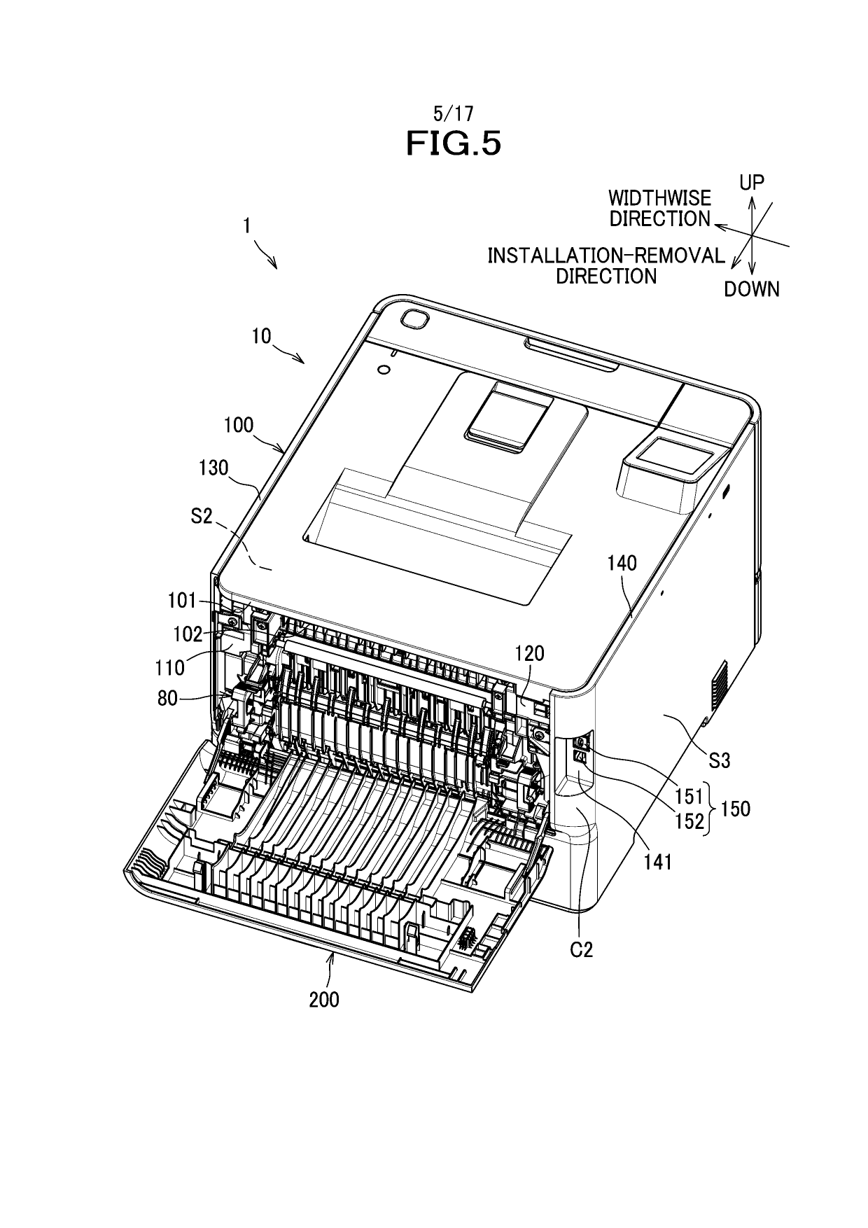

As shown in FIG. 5, the main housing 100 has an opening 102 in a first side surface 101 thereof. The first side surface 101 is a side surface of the main housing 100 on the one side in the installation-removal direction. In this embodiment, the first side surface 101 is a rear side surface of the main housing 100. The first side surface 101 corresponds to the “side surface” of the “main housing” “in which an opening is formed”.

The first exterior surface S1 (see FIG. 4) of the main body 10 is a side surface located on the same side as the first side surface 101 of the main housing 100. In more detail, the first exterior surface S1 is a side surface of main body 10 located on the one side in the installation-removal direction, which is the same side at which the first side surface 101 of the main housing 100 is located.

The rear cover 200 is movable relative to the main housing 100 between a closed position shown in FIG. 4 and an open position shown in FIG. 5. In this embodiment, the rear cover 200 is rotatable relative to the main housing 100 about an axis extending in the widthwise direction, between the closed position and the open position. The closed position is a position in which the rear cover 200 covers at least a portion of the first side surface 101 to close the opening 102. The open position is a position in which the opening 102 is exposed.

The fixing device 80 is installable into the main housing 100 through the opening 102 from the one side toward the other side in the installation-removal direction in a state where the rear cover 200 is located in the open position shown in FIG. 5. In this embodiment, the fixing device 80 can be installed into the main housing 100 from the rear toward the front. The fixing device 80 is removable from the main housing 100 through the opening 102 from the other side toward the one side in the installation-removal direction in the state where the rear cover 200 is located in the open position. In this embodiment, the fixing device 80 can be removed from the main housing 100 from the front toward the rear.

The main housing 100 comprises a first side frame 110, a second side frame 120, a first side cover 130, and a second side cover 140.

The first side frame 110 is a frame located on the one side in the widthwise direction of the main housing 100. The first side frame 110 holds the second main body connector 160 (see FIG. 2) in a manner that allows the second main body connector 160 to move relative to the first side frame 110. The second side frame 120 is a frame located on the other side in the widthwise direction of the main housing 100. The first side frame 110 and the second side frame 120 support the fixing device 80 when the fixing device 80 is installed in the main housing 100.

The first side cover 130 and the second side cover 140 are covers that form the exterior of the main body 10. The first side cover 130 is positioned to cover the first side frame 110 from the one side in the widthwise direction. The second side cover 140 is positioned to cover the second side frame 120 from the other side in the widthwise direction and from the one side in the installation-removal direction.

The main housing 100 forms at least a part of the second exterior surface S2, at least a part of the third exterior surface S3, and the second corner portion C2. Specifically, the first side cover 130 forms at least a part of the second exterior surface S2. The second side cover 140 forms at least a part of the third exterior surface S3, and the second corner portion C2.

The second corner portion C2 has a recess 141. Specifically, the second side cover 140 has the recess 141. The recess 141 is recessed toward the other side in the installation-removal direction. The recess 141 opens toward the one side in the installation-removal direction. Further, the recess 141 opens toward the other side in the widthwise direction.

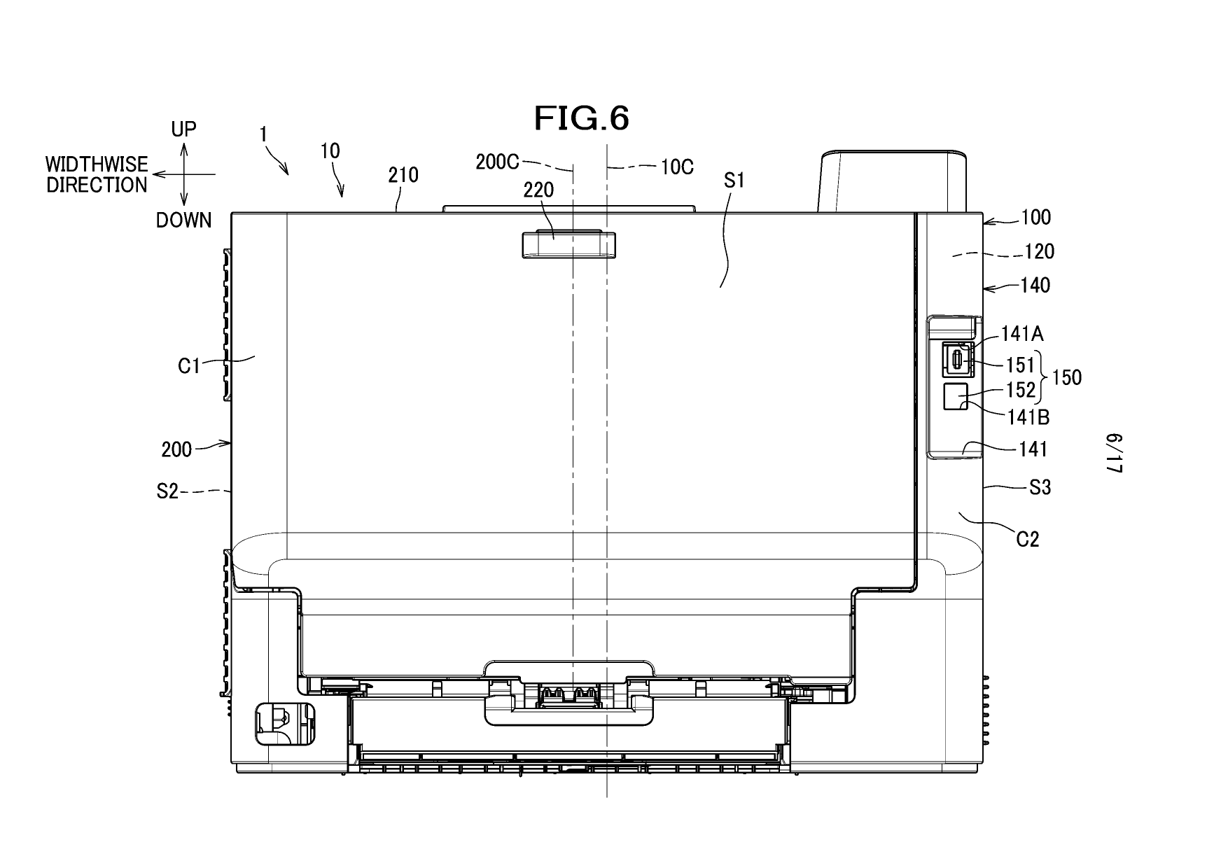

The first main body connector 150 is located in the recess 141. In more detail, as shown in FIG. 6, a first hole 141A and a second hole 141B are formed in the bottom of the recess 141 facing the one side in the installation-removal direction.

The first hole 141A and the second hole 141B are through holes extending in the installation-removal direction and are aligned in the up-down direction. The second hole 141B is located below the first hole 141A. The USB connector 151 is exposed to the outside of the main housing 100 through the first hole 141A. The LAN connector 152 is exposed to the outside of the main housing 100 through the second hole 141B. The USB connector 151 and the LAN connector 152 are held by the second side frame 120.

The rear cover 200 has an asymmetrical shape. In other words, the rear cover 200 has an asymmetrical shape with respect to a straight line extending in the up-down direction (see the dashed-dotted line in FIG. 6 indicating a central portion 200C of the rear cover 200). In more detail, the rear cover 200 forms a part of the first exterior surface S1 and a part of the first corner portion C1 as shown in FIG. 4, in a state where the rear cover 200 is located in the closed position.

In this embodiment, the rear cover 200 forms an upper part of the first exterior surface S1 and an upper part of the first corner portion C1 in the state where the rear cover is located in the closed position. On the other hand, the rear cover does not form any part of the second corner portion C2. In this manner, the rear cover 200 has an asymmetrical shape that forms at least a part of the first corner portion C1 and does not form any part of the second corner portion C2.

The rear cover 200 comprises a cover body 210 and a cover handle 220. The cover body 210 is the portion of the rear cover 200 that covers the opening 102 (see FIG. 5) of the main housing 100 in the state where the rear cover 200 is located in the closed position. The upper part of the first exterior surface S1 and the upper part of the first corner portion C1 are formed by the cover body 210 in the state where the rear cover 200 is located in the closed position.

The cover handle 220 is a part of the rear cover 200 that is graspable when opening and closing the rear cover 200. The cover handle 220 protrudes from the cover body 210 toward the one side in the installation-removal direction in the state where the rear cover 200 is located in the closed position. In this embodiment, the cover handle 220 protrudes rearward from the cover body 210 in the state where the rear cover 200 is located in the closed position.

The cover handle 220 is located at an upper end portion of the rear cover 200 in the state where the rear cover 200 is located in the closed position. As shown in FIG. 6, the cover handle 220 is located at a central portion 200C of the rear cover 200 in the widthwise direction. On the other hand, the cover handle 220 is shifted to the one side in the widthwise direction with respect to a central portion 10C of the main body 10 in the widthwise direction. In other words, the cover handle 220 is located closer to the second exterior surface S2 than to the third exterior surface S3 in the widthwise direction.

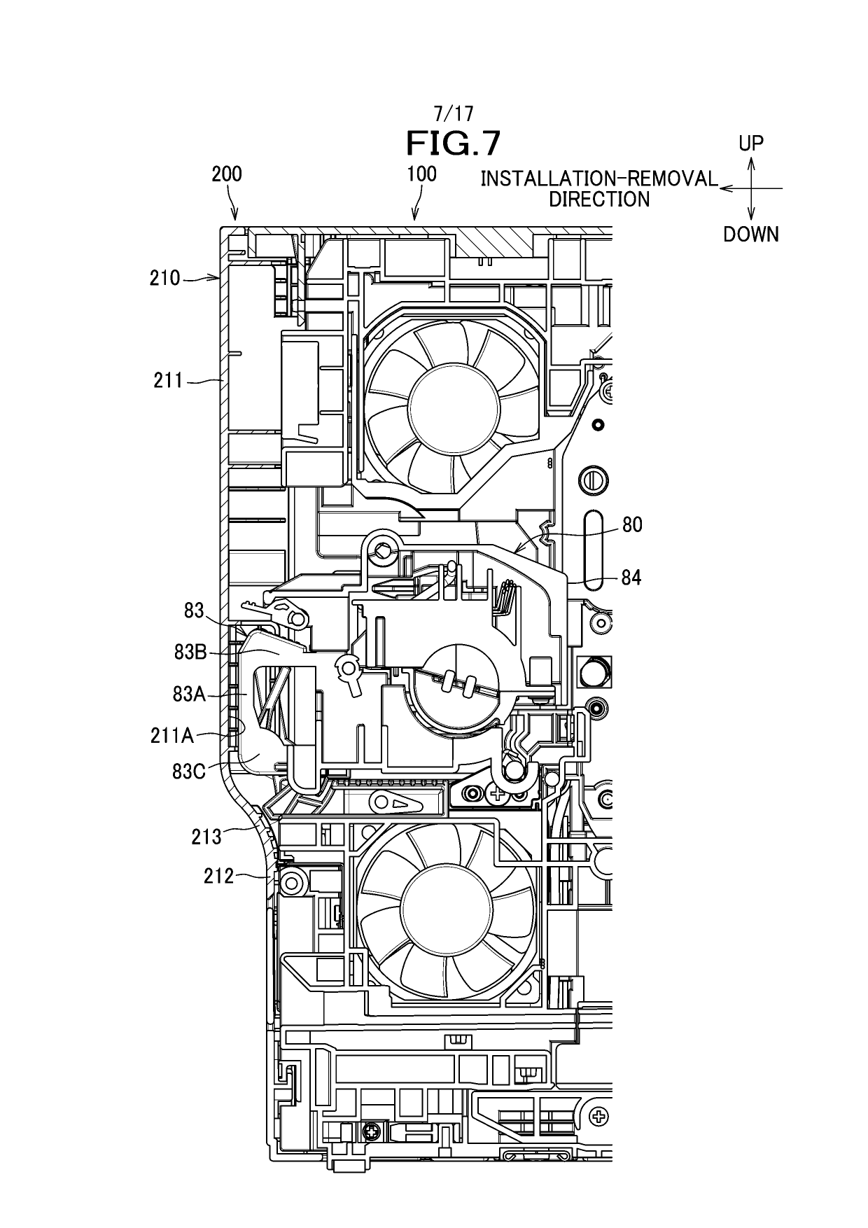

As shown in FIG. 7, the cover body 210 comprises a first portion 211, a second portion 212, and a third portion 213.

The second portion 212 is located below the first portion 211 in the state where the rear cover 200 is located in the closed position. In this embodiment, the second portion 212 forms a lower end of the cover body 210 in the state where the rear cover 200 is located in the closed position.

The first portion 211 forms a major part of the cover body 210. The first portion 211 extends in the up-down direction in the state where the rear cover 200 is located in the closed position. The first portion 211 protrudes further outward, than the second portion 212, toward the one side in the installation-removal direction in the state where the cover 200 is located in the closed position. In this embodiment, the first portion 211 protrudes further rearward than the second portion 212, in the state where the cover 200 is located in the closed position.

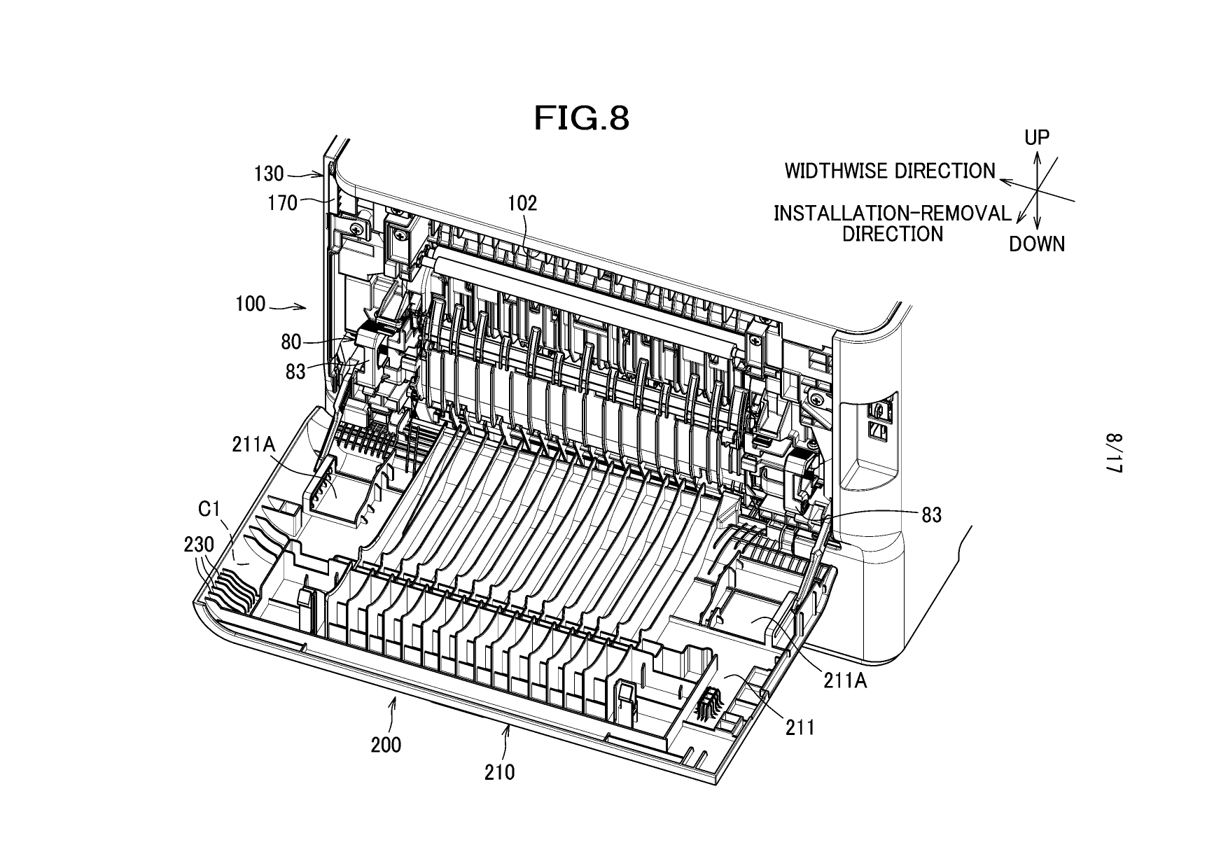

The first portion 211 of the rear cover 200 has recesses 211A formed therein. One of the recesses 211A is formed at an end portion of the first portion 211 at one side in the widthwise direction and another of the recesses 211A is formed at an end portion of the first portion 211 at the other side in the widthwise direction (see FIG. 8). Each recess 211A receives the fixing handle 83 corresponding thereto in the widthwise direction in a state where the fixing device 80 is installed in the main housing 100 and the rear cover 200 is located in the closed position.

The third portion 213 is the portion connecting the first portion 211 and the second portion 212. The third portion 213 extends obliquely upward toward the one side in the installation-removal direction from an upper end of the second portion 212 and is connected to a lower end of the first portion 211, in the state where the rear cover 200 is located in the closed position.

Each fixing handle 83 comprises a grip 83A, a first connecting portion 83B, and a second connecting portion 83C. The grip 83A is a graspable portion of the fixing handle 83. The grip 83A extends in the up-down direction. The first connecting portion 83B and the second connecting portion 83C are portions that connect the grip 83A and the frame 84 of the fixing device 80. The first connecting portion 83B extends from an upper end portion of the grip 83A toward the other side in the installation-removal direction. The second connecting portion 83C extends from a lower end portion of the grip 83A toward the other side in the installation-removal direction. The fixing handle 83 allows a person to insert their hand between the first connecting portion 83B and the second connecting portion 83C from an outer side of the fixing device 80 in the widthwise direction and grasp the grip 83A.

As shown in FIG. 8, the rear cover 200 includes a plurality of cover ribs 230. The main housing 100 includes a rib contacting portion 170.

The plurality of cover ribs 230 are located at an end portion of the rear cover 200 on the one side in the widthwise direction.

The rib contacting portion 170 is located at an end portion of the main housing 100 on the one side in the widthwise direction. The rib contacting portion 170 is located at an end portion of the main housing 100 on the one side in the installation-removal direction. The rib contacting portion 170 is located at an upper end portion of the main housing 100.

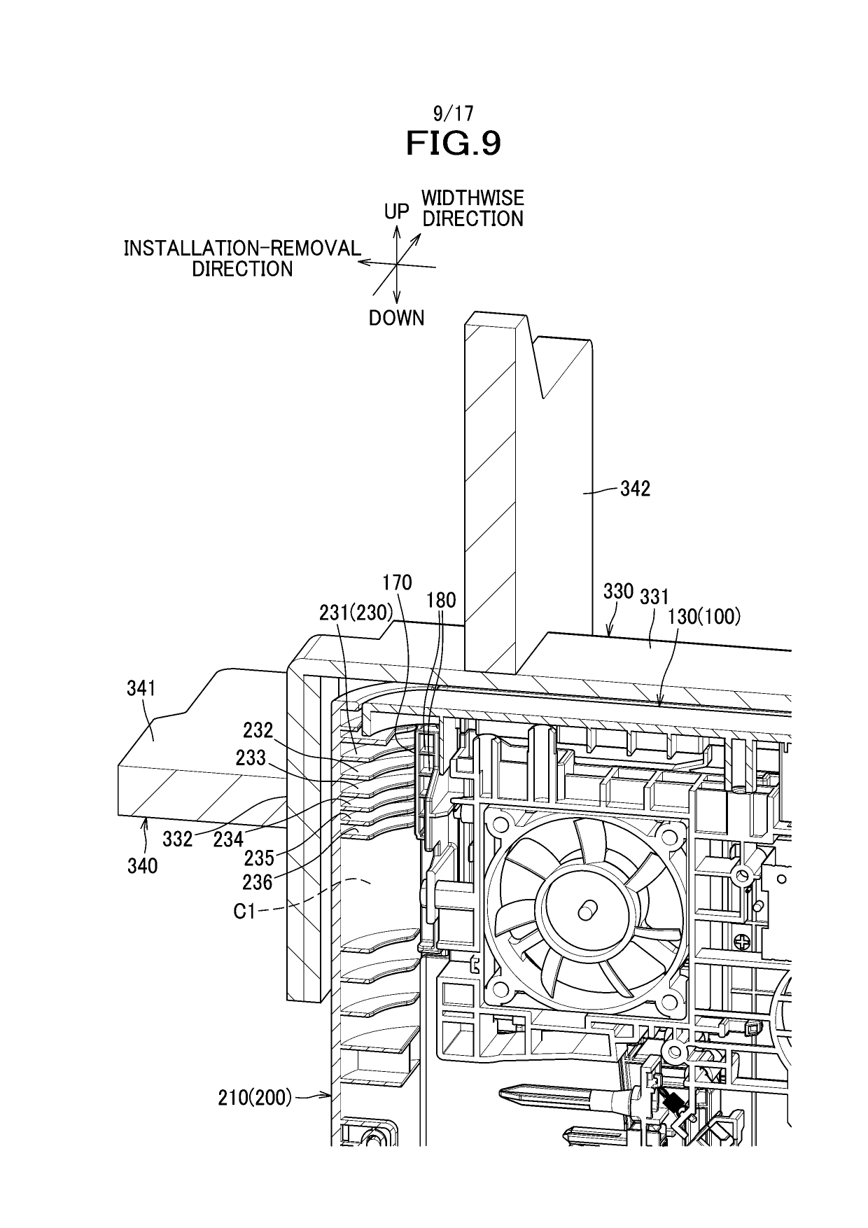

As shown in FIG. 9, the cover ribs 230 protrude from an inner surface of the first corner portion C1 of the cover body 210 toward the other side in the installation-removal direction in the state where the rear cover 200 is located in the closed position. The plurality of cover ribs 230 are aligned in the up-down direction in the state where the rear cover 200 is located in the closed position. The plurality of cover ribs 230 are located at the upper end portion of the rear cover 200 in the state where the rear cover 200 is located in the closed position.

The plurality of cover ribs 230 contact the main housing 100 in the state where the rear cover 200 is located in the closed position. More specifically, the plurality of cover ribs 230 contact the side of the rib contacting portion 170 facing the one side in the installation-removal direction in the state where the rear cover 200 is located in the closed position. In other words, the rib contacting portion 170 contacts the sides of the plurality of cover ribs 230 facing the other side in the installation-removal direction in the state where the rear cover 200 is located in the closed position.

The rib contacting portion 170 extends in the up-down direction. The rib contacting portion 170 is plate-shaped. The main housing 100 further includes a plurality of main body ribs 180. The main body ribs 180 protrude from the rib contacting portion 170 toward the other side in the installation-removal direction. The main body ribs 180 are aligned in the up-down direction. In this embodiment, the rib contacting portion 170 and the main body ribs 180 are formed on the first side cover 130.

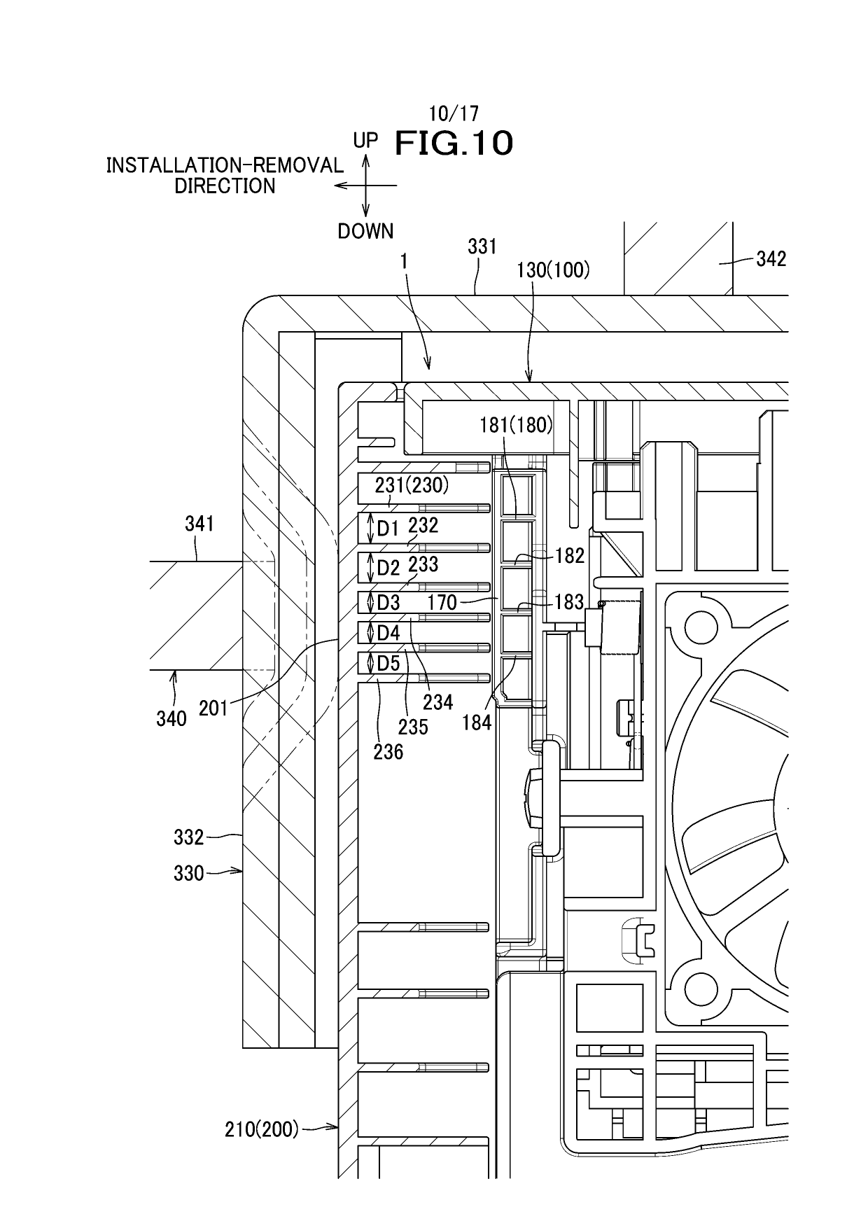

As shown in FIG. 10, some of the cover ribs 230 overlap a corresponding one of the main body ribs 180 as viewed in the installation-removal direction in the state where the rear cover 200 is located in the closed position. In more detail, the cover ribs 230 include a cover rib 231, a cover rib 232, a cover rib 233, a cover rib 234, a cover rib 235, and a cover rib 236. The main body ribs 180 include a main body rib 181, a main body rib 182, a main body rib 183, and a main body rib 184.

The cover ribs 234, 235 of the plurality of cover ribs 230 overlap a corresponding one of the plurality of main body ribs 180 as viewed in the installation-removal direction in the state where the rear cover 200 is located in the closed position. In more detail, the cover rib 234 overlaps the main body rib 183 as viewed in the installation-removal direction. The cover rib 235 overlaps the main body rib 184 as viewed in the installation-removal direction. The cover ribs 231 to 233, and 236 do not overlap any of the main body ribs 180 (181 to 184) as viewed in the installation-removal direction.

The cover ribs 231 to 236 are aligned in this order from the top toward the bottom. The cover rib 231 and the cover rib 232 are arranged next to each other in the up-down direction. The cover rib 232 and the cover rib 233 are arranged next to each other in the up-down direction. The cover rib 233 and the cover rib 234 are arranged next to each other in the up-down direction. The cover rib 234 and the cover rib 235 are arranged next to each other in the up-down direction. The cover rib 235 and the cover rib 236 are arranged next to each other in the up-down direction.

The distance D4 between the adjacent cover ribs 234, 235 is smaller than the distance D1 between the adjacent cover ribs 231, 232. The distance D4 between the adjacent cover ribs 234, 235 is smaller than the distance D2 between the adjacent cover ribs 232, 233. In this embodiment, the cover ribs 234, 235 correspond to “a plurality of first cover ribs”. The cover ribs 231 to 233 correspond to “a plurality of second cover ribs”.

In this embodiment, the distance D1 between the adjacent cover ribs 231, 232 and the distance D2 between the adjacent cover ribs 232, 233 are almost the same. Further, the distance D3 between the adjacent cover ribs 233, 234 and the distance D5 between the adjacent cover ribs 235, 236 are almost the same as the distance D4 between the adjacent cover ribs 234, 235.

The main body ribs 181 to 184 are aligned in this order from the top toward the bottom. The distance between the adjacent main body ribs 181, 182 and the distance between the adjacent main body ribs 182, 183 are almost the same. The distance between the adjacent main body ribs 183, 184 is slightly smaller than the distance between the adjacent main body ribs 181, 182 or the distance between the adjacent main body ribs 182, 183.

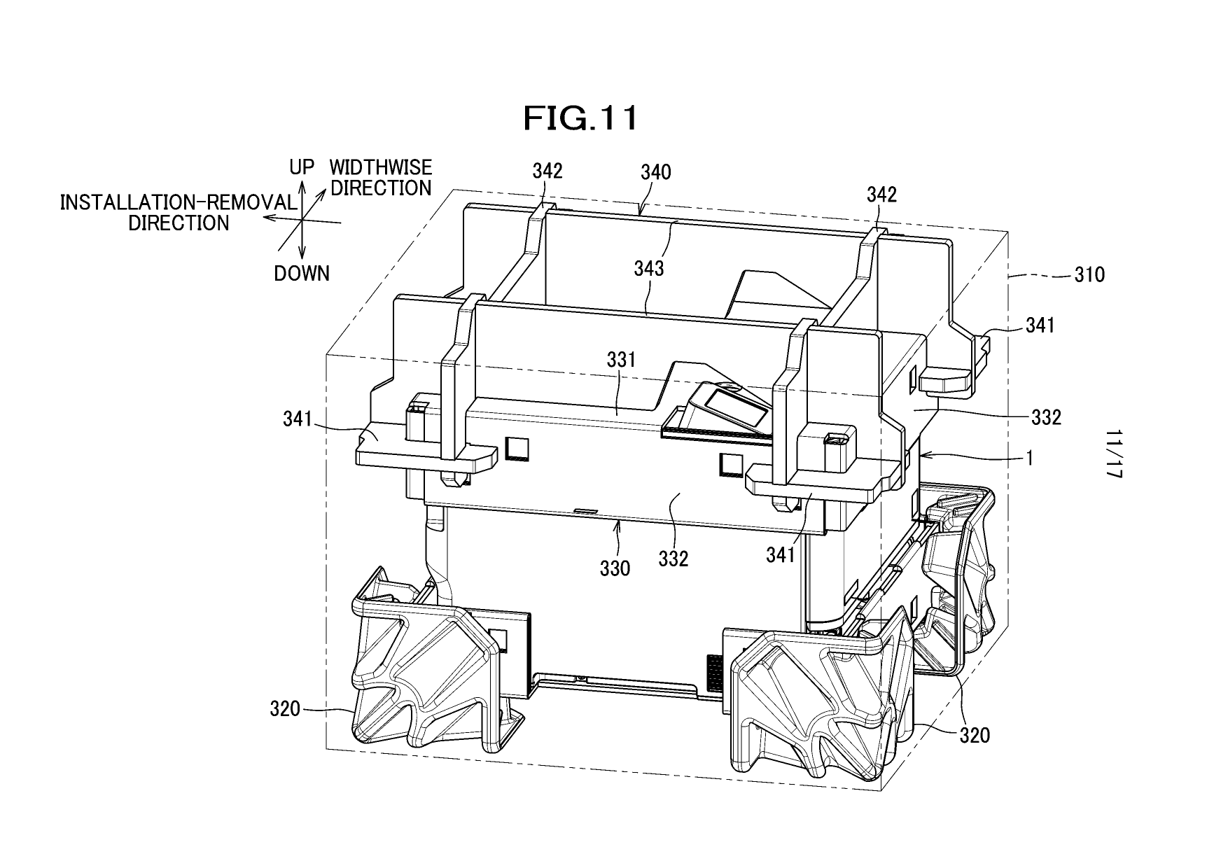

As shown in FIG. 11, the image forming apparatus 1 is shipped in a packaging box 310. In one example, the packaging box 310 is a corrugated cardboard box. Cushioning materials 320, 330, 340 are disposed between the image forming apparatus 1 and the packaging box 310.

The cushioning materials 320 are positioned one at each of the four bottom corners of the packaging box 310. In one example, the cushioning materials 320 are made of molded pulp.

The cushioning material 330 is a lid-shaped member placed on top of the image forming apparatus 1. The cushioning material 330 comprises an upper wall 331 and four side walls 332, i.e., a rearward side wall 332, a frontward side wall 332, a leftward side wall 332 and a rightward side wall 332. In one example, the cushioning material 330 is made from sheets of corrugated cardboard.

The cushioning material 340 is assembled from four first sheets 341, two second sheets 342, and two third sheets 343. In one example, the first sheets 341, the second sheets 342, and the third sheets 343 are sheets of corrugated cardboard.

As shown in FIG. 10, one of the first sheets 341 of the cushioning material 340 is opposed to the rear cover 200 with the rearward side wall 332 of the cushioning material 330 disposed between the first sheet 341 and the rear cover 200. As shown by dashed-double dotted lines, if the rearward side wall 332 of the cushioning material 330 deforms by being pushed by the cushioning material 340 from behind due to impacts during transportation, the first sheet 341 of the cushioning material 340 may contact the rear cover 200 with the side wall 332 disposed between the first sheet 341 and the rear cover 200. Here, the portion of the rear cover 200 contactable by the first sheet 341 will be referred to as a load-receiving portion 201.

In this embodiment, the cover ribs 233 to 236 are formed on a back surface of the load-receiving portion 201. The distance D3 between the adjacent cover ribs 233, 234, the distance D4 between the adjacent cover ribs 234, 235, and the distance D5 between the adjacent cover ribs 235, 236 are smaller than the distance D1 between the adjacent cover ribs 231, 232 or the distance D2 between the adjacent cover ribs 232, 233.

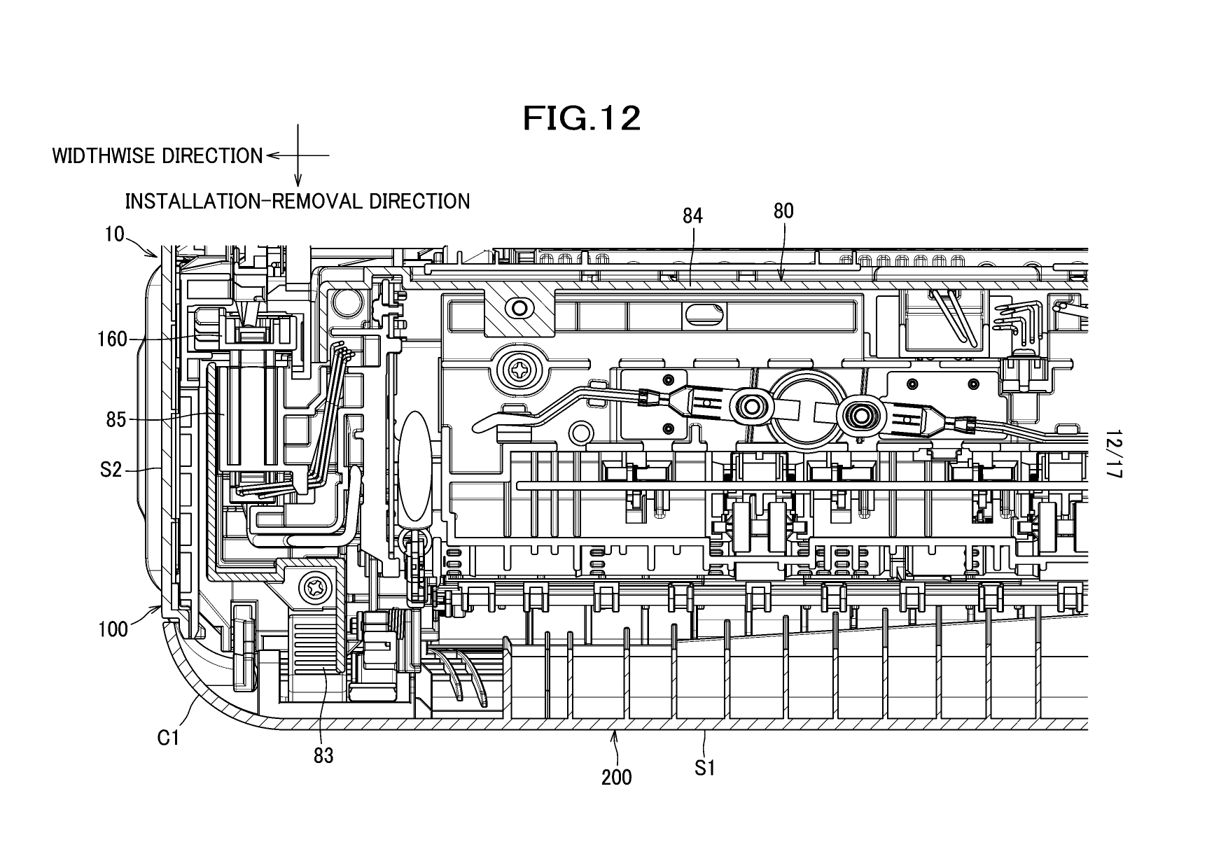

As shown in FIG. 12, the rear cover 200 overlaps the fixing device 80 as viewed in the installation-removal direction in the state where the fixing device 80 is installed in the main housing 100 and the rear cover 200 is located in the closed position. Specifically, the first corner portion C1 overlaps the fixing connector 85 as viewed in the installation-removal direction in the state where the fixing device 80 is installed in the main housing 100 and the rear cover 200 is located in the closed position.

In more detail, a part of the first corner portion C1 formed by the rear cover 200 overlaps the fixing connector 85 as viewed in the installation-removal direction in the state where the fixing device 80 is installed in the main housing 100 and the rear cover 200 is located in the closed position. Further, the part of the first corner portion C1 formed by the rear cover 200 overlaps the second main body connector 160 as viewed in the installation-removal direction in the state where the rear cover 200 is located in the closed position.

The rear cover 200 overlaps the fixing device 80 as viewed in the widthwise direction in the state where the fixing device 80 is installed in the main housing 100 and the rear cover 200 is located in the closed position. In more detail, the rear cover 200 overlaps the fixing handle 83 as viewed in the widthwise direction in the state where the fixing device 80 is installed in the main housing 100 and the rear cover 200 is located in the closed position. The rear cover 200 covers the fixing handle 83 located at an end portion of the fixing device 80 on the one side in the widthwise direction from the one side in the widthwise direction in the state where the fixing device 80 is installed in the main housing 100 and the rear cover 200 is located in the closed position.

The first corner portion C1 overlaps the fixing handle 83 as viewed in the widthwise direction in the state where the fixing device 80 is installed in the main housing 100 and the rear cover 200 is located in the closed position. In more detail, the part of the first corner portion C1 formed by the rear cover 200 overlaps the fixing handle 83 as viewed in the widthwise direction in the state where the fixing device 80 is installed in the main housing 100 and the rear cover 200 is located in the closed position.

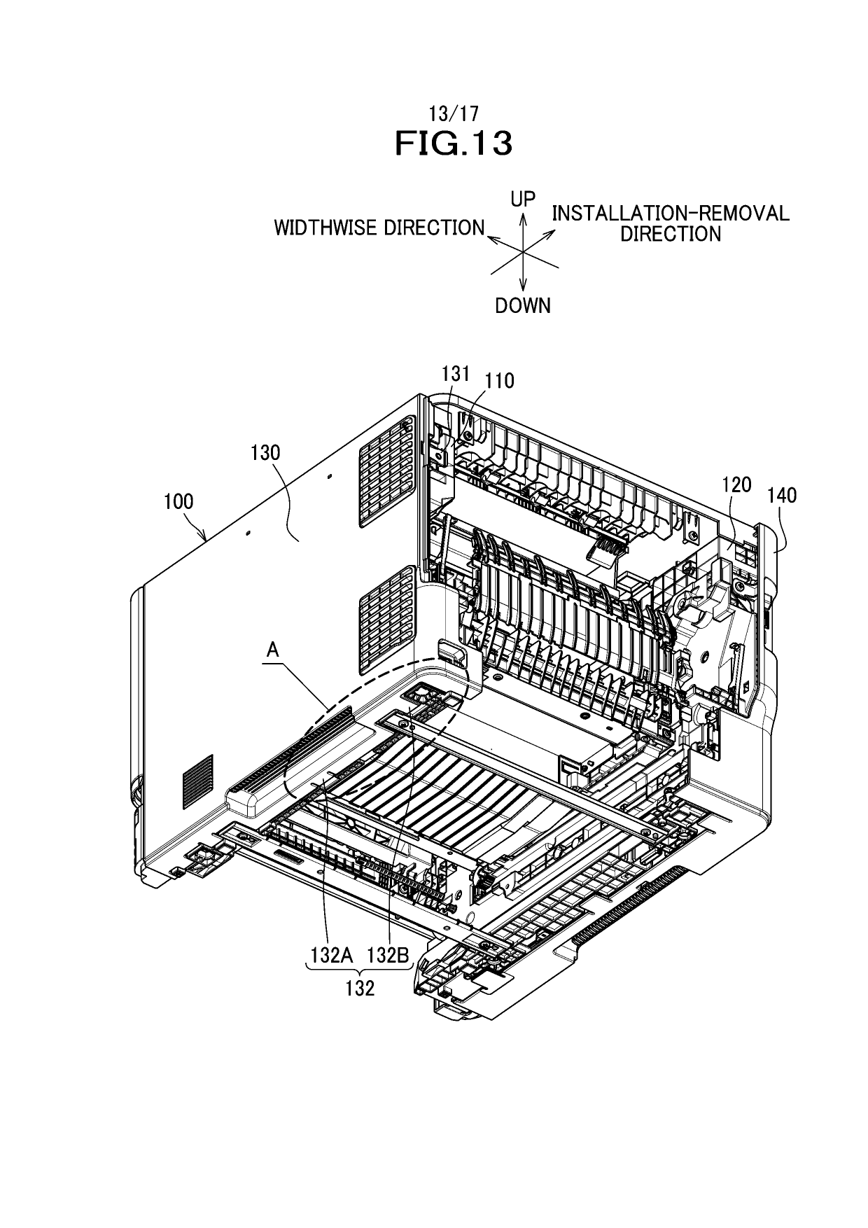

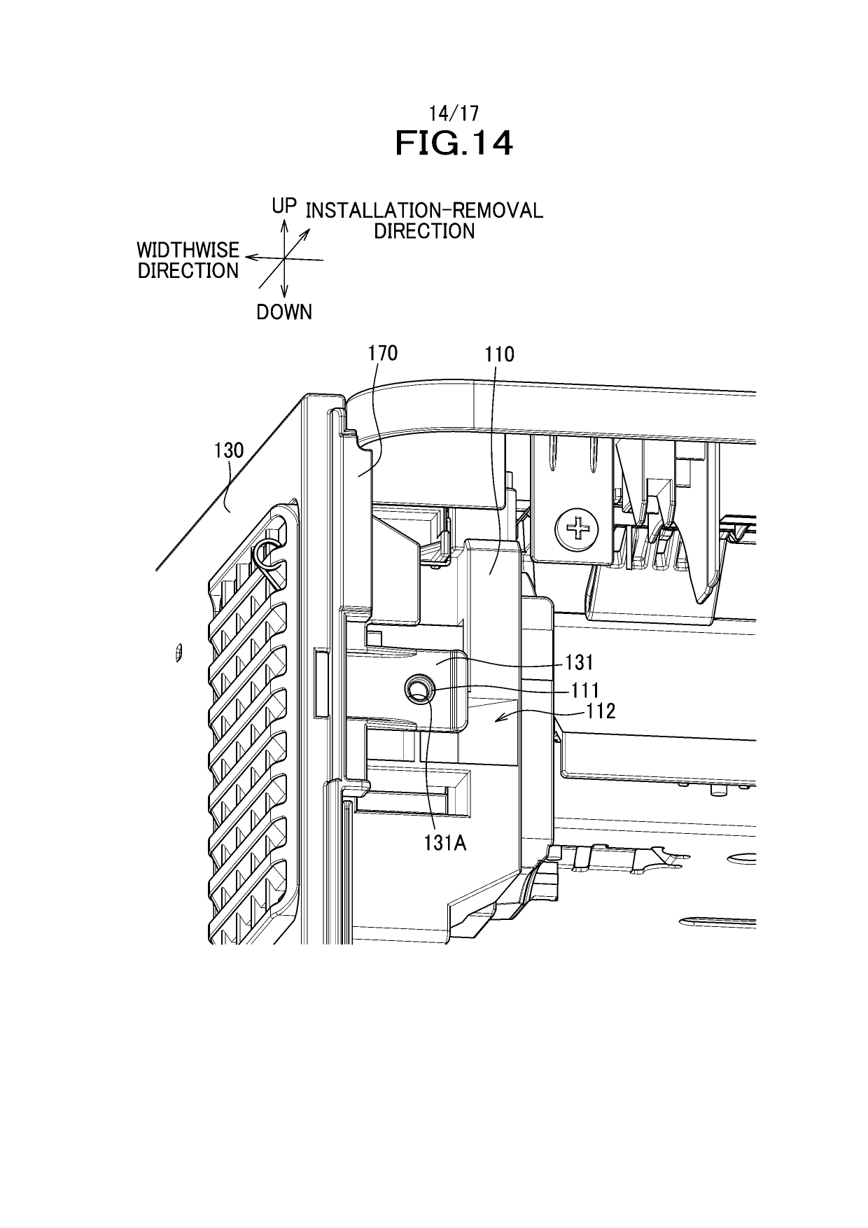

As shown in FIGS. 13 and 14, the first side frame 110 and the first side cover 130 are fixed to each other at upper end portions thereof at ends thereof on the one side in the installation-removal direction. Specifically, the first side cover 130 includes a fixing piece 131 extending toward the other side in the widthwise direction. As shown in FIG. 14, the fixing piece 131 has a through hole 131A. The through hole 131A extends through the fixing piece 131 in the installation-removal direction.

The first side frame 110 has a boss 111 protruding toward the one side in the installation-removal direction. The boss 111 is engageable with the through hole 131A in the fixing piece 131. The boss 111 has a shape of a hollow cylinder with a bottom. The boss 111 opens toward the one side in the installation-removal direction. The first side frame 110 and the first side cover 130 are fixed to each other by engaging the boss 111 with the through hole 131A in the fixing piece 131 and fastening a screw (not shown) to the boss 111 from the one side in the installation-removal direction.

The first side frame 110 has a recess 112 on the other side in the installation-removal direction with respect to the fixing piece 131. The recess 112 is recessed toward the other side in the installation-removal direction. The recess 112 forms a clearance between the fixing piece 131 and the first side frame 110 in the installation-removal direction. This recess 112 allows a person to insert their fingers between the fixing piece 131 and the first side frame 110.

When the first side cover 130 is to be detached from the first side frame 110, firstly, the screw, fixing the first side frame 110 and the first side cover 130, is removed from the boss 111. Then, a person inserts their fingers into the recess 112 and causes the fixing piece 131 to deform toward the one side in the installation-removal direction so that the fixing piece 131 can be easily disengaged from the boss 111. In this way, the first side cover 130 can be easily removed from the first side frame 110.

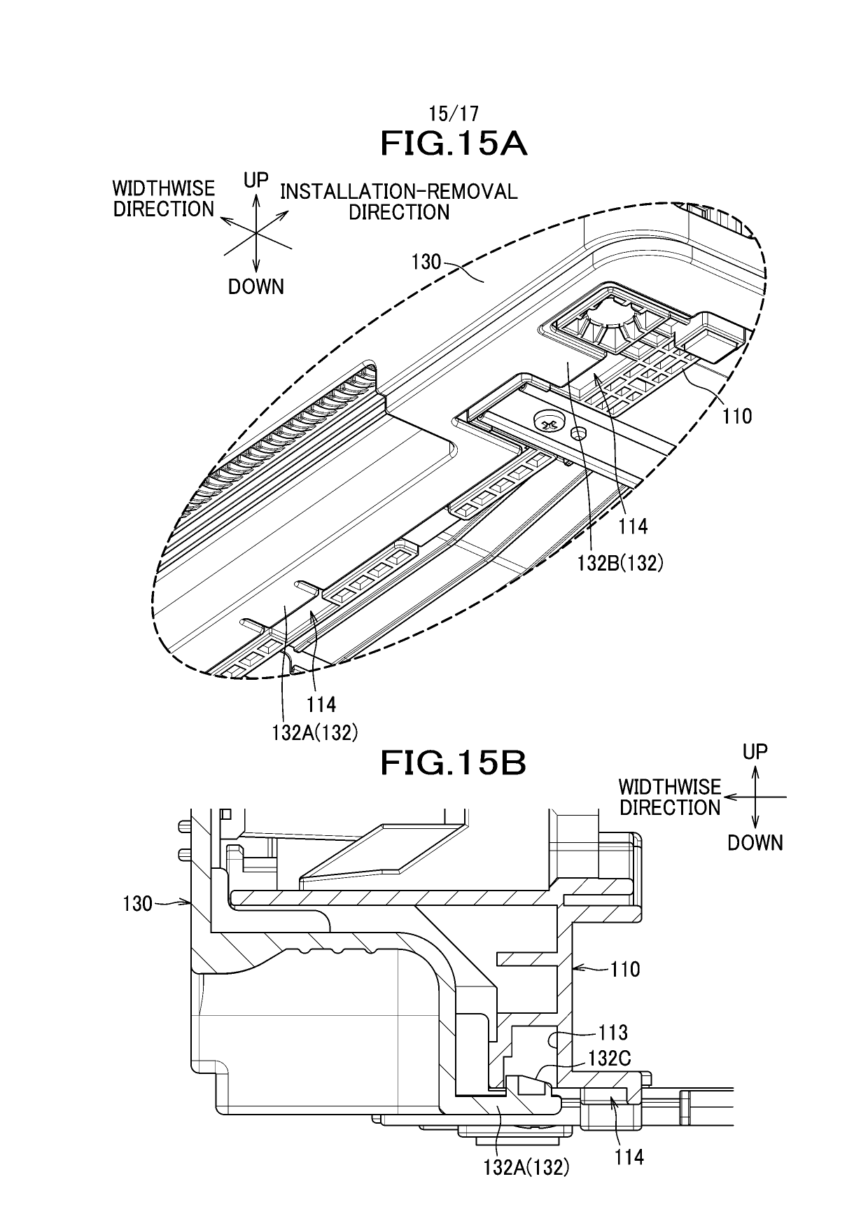

As shown in FIGS. 13 and 15A, the first side frame 110 and the first side cover 130 are also fixed to each other at bottom end portions thereof. Specifically, the first side cover 130 includes engagement pieces 132 extending toward the other side in the widthwise direction. The engagement pieces 132 include a first engagement piece 132A and a second engagement piece 132B. The second engagement piece 132B is located further toward the one side in the installation-removal direction than the first engagement piece 132A.

FIG. 15B shows the first engagement piece 132A, which represents both engagement pieces 132. The first engagement piece 132A and the second engagement piece 132B respectively include lugs 132C protruding upward on ends thereof on the other side in the widthwise direction. The first side frame 110 has holes 113 recessed upward. The first side frame 110 and the first side cover 130 are fixed to each other by engaging the lugs 132C of the engagement pieces 132 with the corresponding holes 113.

As shown in FIGS. 15A and 15B, the first side frame 110 has recesses 114 on the other side in the widthwise direction with respect to the engagement pieces 132 (132A, 132B). The recesses 114 are recessed upward. The recesses 114 are located on the other side in the widthwise direction with respect to the holes 113. The recesses 114 form clearances between the engagement pieces 132 and the first side frame 110 in the widthwise direction. These recesses 114 allow a person to insert their fingers between the engagement pieces 132 and the first side frame 110.

When the side cover 130 is to be detached from the first side frame 110, a person inserts their fingers in the recesses 114 and causes the engagement pieces 132 to deform downward so that the lugs 132C can be easily disengaged from the holes 113. In this way, the first side cover 130 can be easily detached from the first side frame 110.

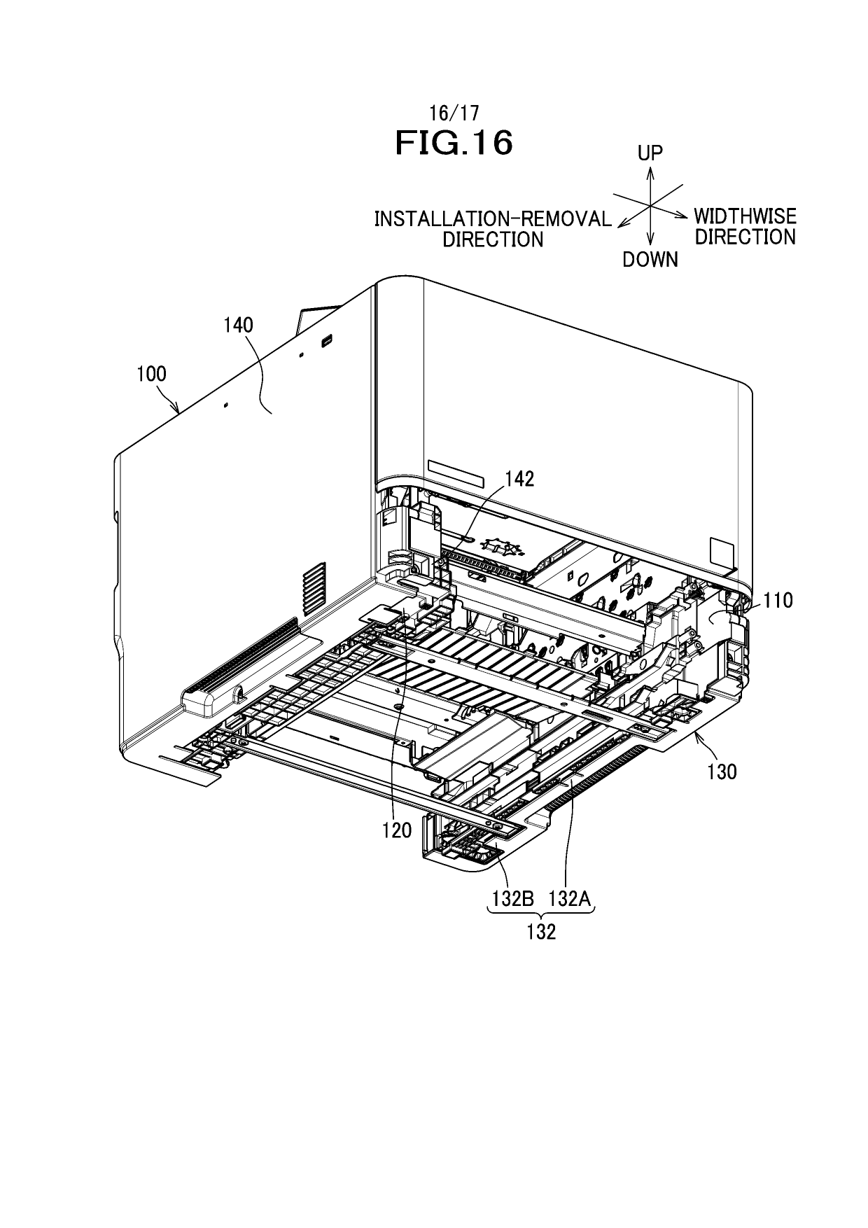

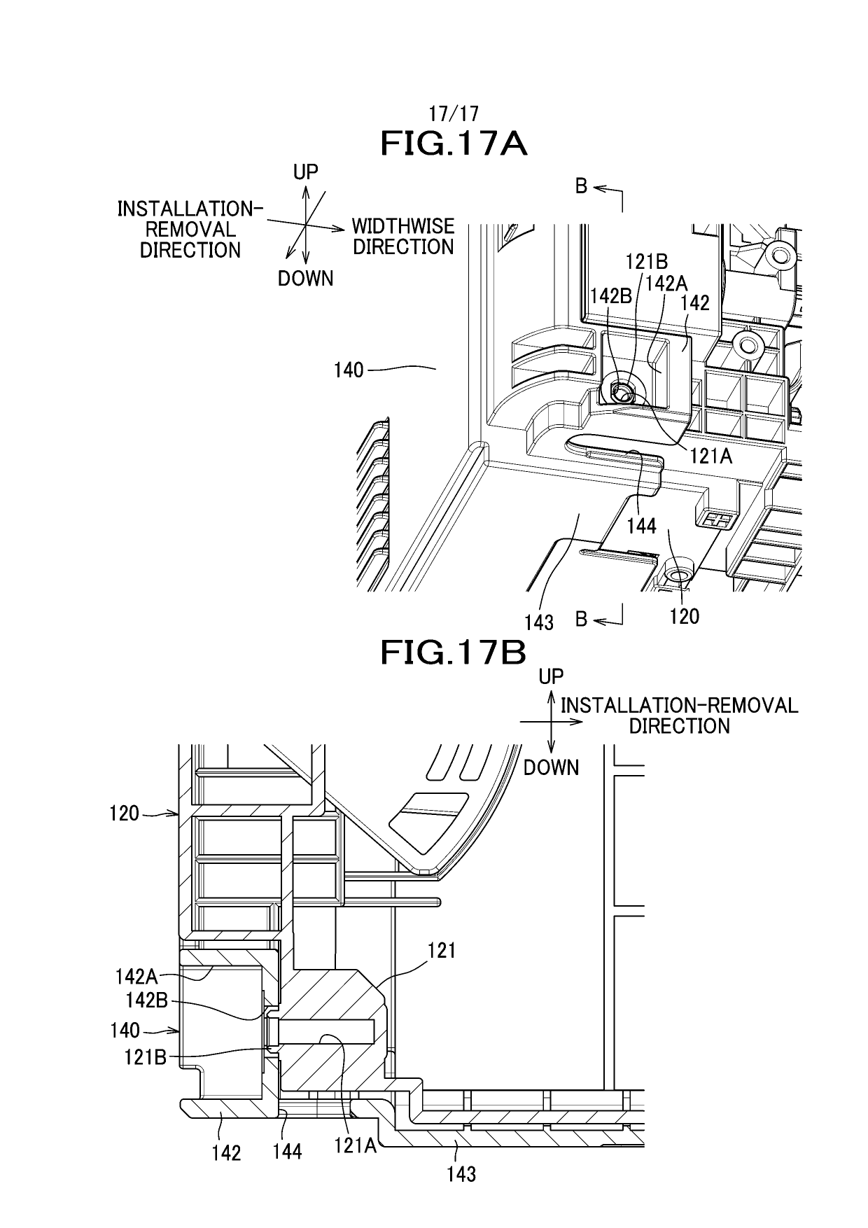

As shown in FIGS. 16 and 17A, the second side frame 120 and the second side cover 140 are fixed to each other at bottom end portions thereof at ends thereof on the other side in the installation-removal direction. Specifically, the second side cover 140 has a protrusion 142 protruding toward the one side in the widthwise direction.

As shown in FIGS. 17A and 17B, a recess 142A is formed in the protrusion 142. The recess 142A is recessed toward the one side in the installation-removal direction. A through hole 142B is formed in the bottom of the recess 142A. The through hole 142B extends in the installation-removal direction.

The second side frame 120 comprises a fixing portion 121 to which the protrusion 142 is fixed. The fixing portion 121 has a blind hole 121A and a projection 121B having a shape of a hollow cylinder. The projection 121B is engageable with the through hole 142B in the protrusion 142. The projection 121B protrudes from the periphery of the hole 121A toward the other side in the installation-removal direction.

The second side frame 120 and the second side cover 140 are fixed to each other by engaging the projection 121B with the through hole 142B in the protrusion 142 and fastening a screw (not shown) to the hole 121A in the fixing portion 121 from the other side in the installation-removal direction.

The second side cover 140 has a slit 144 formed between the protrusion 142 and a lower wall 143 of the second side cover 140. The slit 144 extends in the widthwise direction. The slit 144 opens toward the one side in the widthwise direction. The slit 144 extends through the second side cover 140 in the up-down direction.

To detach the second side cover 140 from the second side frame 120, firstly, the screw, fixing the second side frame 120 and the second side cover 140, is removed from the fixing portion 121. Then, by causing the protrusion 142 to deform toward the other side in the installation-removal direction, the through hole 142B in the protrusion 142 can be disengaged from the projection 121B of the fixing portion 121.

At this time, since the second side cover 140 has the slit 144, the protrusion 142 can be easily deformed toward the other side in the installation-removal direction compared to an alternative configuration that does not have the slit 144. In this way, the second side cover 140 can be easily detached from the second side frame 120.

Next, the advantageous effects of this embodiment will be described.

The first corner portion C1 overlaps the fixing connector 85 as viewed in the installation-removal direction in the state where the fixing device 80 is installed in the main housing 100 and the rear cover 200 is located in the closed position; thus, the image forming apparatus 1 that allows the fixing device 80 to be installed therein and removed therefrom can be restrained from increasing in size compared to an alternative configuration in which the first corner portion does not overlap the fixing connector 85 as viewed in the installation-removal direction.

Since a space is formed on the one side in the installation-removal direction with respect to the fixing connector 85 (fixing device 80) when the rear cover 200 is opened, the fixing device 80 can be drawn almost straight out from the other side toward the one side in the installation-removal direction. In this way, the fixing device 80 can be easily removed from the main housing 100.

The rear cover 200 has a plurality of cover ribs 230 protruding from the inner surface of the first corner portion C1; thus, the first corner portion C1 can be reinforced.

The main housing 100 includes the rib contacting portion 170 contacted by the plurality of cover ribs 230 and extending in the up-down direction; thus, the load received from the cover ribs 230 can be distributed therethrough.

The main housing 100 includes the plurality of main body ribs 180 protruding from the rib contacting portion 170; thus, the rib contacting portion 170 can be reinforced.

The plurality of cover ribs 230 overlap a corresponding one of the plurality of main body ribs 180 as viewed in the installation-removal direction in the state where the rear cover 200 is located in the closed position; thus, the portion of the rib contacting portion 170 that receives the load from the cover ribs 230 can be reinforced.

The distance D3 between adjacent cover ribs 233, 234, the distance D4 between adjacent cover ribs 234, 235, and the distance D5 between adjacent cover ribs 235, 236 are smaller than the distance D1 between adjacent cover ribs 231, 232 or the distance D2 between adjacent cover ribs 232, 233; thus, the portion of the rear cover 200 in which the cover ribs 233 to 236 are formed, i.e., the load-receiving portion 201 (see FIG. 10), can be reinforced.

Each of the cover ribs 234, 235 overlaps one of the plurality of main body ribs 180 as viewed in the installation-removal direction in the state where the rear cover 200 is located in the closed position; thus, the portion of the rib contacting portion 170 that receives the load from the cover ribs 234, 235 can be reinforced by the main body ribs 180 (183, 184). Thus, the portion of the rear cover 200 in which the cover ribs 234, 235 are formed, i.e., the load-receiving portion 201, can further be reinforced.

The rear cover 200 covers the fixing handle 83 located at the end portion of the fixing device 80 on the one side in the widthwise direction from the one side in the widthwise direction in the state where the fixing device 80 is installed in the main housing 100 and the rear cover 200 is located in the closed position; thus, the fixing handle 83 can be exposed when the rear cover 200 is opened. In this way, it is easier to visually identify and grasp the fixing handle 83.

The rear cover 200 has a recess 211A in which the fixing handle 83 is received in the state where the fixing device 80 is installed in the main housing 100 and the rear cover 200 is located in the closed position; thus, the fixing handle 83 protrudes toward the one side in the installation-removal direction when the rear cover 200 is opened and the fixing handle 83 is thereby easily graspable.

The first main body connector 150 is located in the recess 141 of the second corner portion C2 formed by the second side cover 140. Since the second side cover 140 (main housing 100) does not move unlike the rear cover 200, the first main body connector 150 and cables connected thereto can be appropriately protected.

The rear cover 200 overlaps the fixing device 80 as viewed in the installation-removal direction and as viewed in the widthwise direction, in a state where the fixing device 80 is installed in the main housing 100 and the rear cover 200 is located in the closed position; thus, the image forming apparatus 1 that allows the fixing device 80 to be installed therein and removed therefrom can be restrained from increasing in size compared to an alternative configuration in which the rear cover does not overlap the fixing device 80, for example, a configuration in which the rear cover located in the closed position is located rearward of the fixing device 80.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiment, a plurality of cover ribs 234, 235 (first cover ribs) overlap a corresponding one of the plurality of main body ribs 180 as viewed in the installation-removal direction in the state where the rear cover 200 is located in the closed position. However, only one of the plurality of first cover ribs may, for example, overlap a corresponding one of the plurality of main body ribs as viewed in the installation-removal direction in the state where the cover is located in the closed position.

At least one of the plurality of second cover ribs may overlap a corresponding one of the plurality of main body ribs as viewed in the installation-removal direction in the state where the cover is located in the closed position. Further, only one of the plurality of cover ribs, including the first cover ribs and the second cover ribs, may overlap one of the plurality of main body ribs as viewed in the installation-removal direction in the state where the cover is located in the closed position. The plurality of cover ribs do not need to overlap the plurality of main body ribs as viewed in the installation-removal direction in the state where the cover is located in the closed position.

Although the distance D4 between the adjacent cover ribs 234, 235 is smaller than the distance D1 between the adjacent cover ribs 231, 232 or the distance D2 between the adjacent cover ribs 232, 233 in the above-described embodiment, the distance between adjacent cover ribs may, for example, be almost the same. The cover does not have to include cover ribs protruding from the inner surface of the first corner portion.

Although the rib contact portion 170 is formed on the first side cover 130 in the above-described embodiment, the rib contact portion may, for example, be formed on the first side frame 110. Although the rib contact portion 170 extends in the up-down direction in the above-described embodiment, the rib contact portion does not have to extend in the up-down direction. Further, the main housing does not have to include the main body ribs protruding from the rib contact portion.

Although the cover handle 220 is located at the central portion of the rear cover 200 in the widthwise direction in the above-described embodiment, the cover handle may, for example, be located at the central portion of the main body in the widthwise direction. Although the cover handle 220 protrudes from the cover body 210 in the above-described embodiment, the cover handle may, for example, be a recess into which a person may insert their fingers.

Although the engagement portion is a fixing connector 85 in the above-described embodiment, the engagement portion does not have to be a connector. For example, the engagement portion may be a projection formed on the frame of the fixing device and configured to engage a hole formed in the main housing in the state where the fixing device is installed in the main housing. Further, the engagement portion may, for example, be a recess formed in the frame of the fixing device and configured to engage a protrusion formed on the main housing in the state where the fixing device is installed in the main housing.

In the above-described embodiment, the rear cover 200 overlaps the fixing device 80 as viewed in the widthwise direction in the state where the fixing device 80 is installed in the main housing 100 and the rear cover 200 is located in the closed position. However, the cover does not have to overlap the fixing device as viewed in the widthwise direction in the state where the fixing device is installed in the main housing and the cover is located in the closed position.

Although the rear cover 200 located in the closed position forms a part of the first exterior surface S1 in the above-described embodiment, the cover located in the closed position may, for example, form the whole first exterior surface. Although the rear cover 200 located in the closed position forms a part of the first corner portion C1 in the above-described embodiment, the cover located in the closed position may, for example, form the whole first corner portion C1.

The cover in the closed position may form a part of the second exterior surface. The cover in the closed position may form at least a part of the second corner portion. The cover in the closed position may form a part of the third exterior surface. The cover may have a symmetrical shape.

Although the rear cover 200 is configured such that the first portion 211 protrudes further than the second portion 212, toward the one side in the installation-removal direction in the state where the cover 200 is located in the closed position in the above-described embodiment, the cover in the closed position may extend straight in the up-down direction.

In the above-described embodiment, the rear cover 200 that is configured to cover and uncover the opening 102 in the rearward side surface of the main housing 100 is given as an example of the cover. However, the cover may, for example, be a cover configured to cover and uncover an opening in the rightward or leftward side surface of the main housing. The cover may be a cover configured to cover and uncover an opening in the forward side surface of the main housing.

Although the heating member 81 of the fixing device 80 comprises the heating roller 81A in the above-described embodiment, the fixing device may, for example, comprise a heating belt or a heating film in place of the heating roller. Although the pressure member 82 of the fixing device 80 comprises the pressure roller 82A in the above-described embodiment, the fixing device may, for example, comprise an endless belt and an elastic pad configured to hold the belt in cooperation with the heating member in place of the pressure roller.

Although the image forming apparatus 1 is a color printer capable of forming a multicolor image in the above-described embodiment, the image forming apparatus may, for example, be a monochrome printer capable of forming only a monochrome image. Further, the image forming apparatus may, for example, be a copying machine, a multifunction machine, etc.

The elements described in the above embodiment and its modifications may be implemented selectively and in combination.

WHAT IS CLAIMED IS:

1. An image forming apparatus, comprising:
a main body comprising:
a main housing having an opening in a first side surface thereof; and
a cover movable between a closed position in which the cover is placed over at least a part of the first side surface to cover the opening, and an open position in which the opening is uncovered; and
a fixing device installable into and removable from the main housing through the opening in a state where the cover is located in the open position, the fixing device being installable into the main housing from one side toward another side in an installation-removal direction and removable from the main housing from the another side toward the one side in the installation-removable direction, wherein
in a state where the cover is located in the closed position, the main body has:
a first exterior surface that is a side surface located on a same side of the main housing as a side on which the first side surface is located;
a second exterior surface that is a side surface located on one side in a widthwise direction perpendicular to the installation-removal direction and to an up-down direction with respect to the first exterior surface; and
a curved first corner portion connecting the first exterior surface and the second exterior surface,
the cover located in the closed position is configured to form at least a part of the first exterior surface and at least a part of the first corner portion,
the fixing device comprises an engagement portion located at one end thereof on the one side in the widthwise direction and configured to be engaged with the main housing in a state where the fixing device is installed in the main housing, and
the first corner portion overlaps the engagement portion as viewed in the installation-removable direction in a state where the fixing device is installed in the main housing and the cover is located in the closed position.

2. The image forming apparatus according to claim 1, wherein the cover incudes a plurality of cover ribs protruding from an inner surface of the first corner portion toward the another side in the installation-removal direction and contacting the main housing in the state where the cover is located in the closed position, the cover ribs being aligned in the up-down direction.

3. The image forming apparatus according to claim 2, wherein the main housing comprises a rib contacting portion contacted by the plurality of cover ribs in the state where the cover is located in the closed position, the rib contacting portion extending in the up-down direction.

4. The image forming apparatus according to claim 3, wherein
the main housing comprises a first side cover configured to form at least a part of the second exterior surface, and
the rib contacting portion is formed on the first side cover.

5. The image forming apparatus according to claim 3, wherein the main housing comprises a plurality of main body ribs protruding from the rib contacting portion toward the another side in the installation-removal direction and aligned in the up-down direction.

6. The image forming apparatus according to claim 5, wherein at least one of the plurality of cover ribs overlap a corresponding one of the plurality of main body ribs as viewed in the installation-removal direction in the state where the cover is located in the closed position.

7. The image forming apparatus according to claim 5, wherein
the plurality of cover ribs include:
a plurality of first cover ribs arranged next to each other in the up-down direction; and
a plurality of second cover ribs arranged next to each other in the up-down direction, and
a distance between the first cover ribs arranged next to each other are smaller than a distance between the second cover ribs arranged next to each other.

8. The image forming apparatus according to claim 7, wherein at least one of the plurality of first cover ribs overlaps a corresponding one of the plurality of main body ribs as viewed in the installation-removal direction in the state where the cover is located in the closed position.

9. The image forming apparatus according to claim 1, wherein
the fixing device comprises a fixing handle graspable when the fixing device is installed into and removed from the main housing, the fixing handle being located at the one end of the fixing device on the one side in the widthwise direction, and
the cover is configured to cover the fixing handle from the one side in the widthwise direction in the state where the fixing device is installed in the main housing and the cover is located in the closed position.

10. The image forming apparatus according to claim 1, wherein
the fixing device comprises a fixing handle graspable when the fixing device is installed into and removed from the main housing, the fixing handle protruding toward the one side in the installation-removal direction, and
the cover has a recess configured to receive the fixing handle in the state where the fixing device is installed in the main housing and the cover is located in the closed position.

11. The image forming apparatus according to claim 10, wherein
the cover includes:
a first portion in which the recess is formed; and
a second portion located below the first portion, and
the first portion protrudes further outward, than the second portion, toward the one side in the installation-removal direction in the state where the cover is located in the closed position.

12. The image forming apparatus according to claim 1, wherein the cover has an asymmetrical shape.

13. The image forming apparatus according to claim 12, wherein
the main body further comprises:
a third exterior surface that is a side surface located on another side in the widthwise direction with respect to the first exterior surface; and
a curved second corner portion connecting the first exterior surface and the third exterior surface, and
the main housing forms the second corner portion.

14. The image forming apparatus according to claim 13, wherein the main housing comprises a second side cover forming at least a part of the third exterior surface and the second corner portion.

15. The image forming apparatus according to claim 13, wherein
the main body further comprises a main body connector to which a cable is electrically connected,
the second corner portion has a recess recessed toward the another side in the installation-removal direction, the main body connector being located in the recess.

16. The image forming apparatus according to claim 12, wherein the cover comprises a cover handle graspable when opening and closing the cover, the cover handle being located at a central portion of the cover in the widthwise direction.

17. The image forming apparatus according to claim 16, wherein the cover handle protrudes toward the one side in the installation-removal direction in the state where the cover is located in the closed position.

18. The image forming apparatus according to claim 1, wherein
the main body comprises a main body connector to which the fixing device is electrically connected, and
the engagement portion is a fixing connector connected to the main body connector in the state where the fixing device is installed in the main housing.

19. An image forming apparatus, comprising:
a main housing having an opening in a side surface thereof;
a cover movable between a closed position in which the cover is placed over at least a part of the side surface to cover the opening, and an open position in which the opening is uncovered; and
a fixing device installable into and removable from the main housing through the opening in a state where the cover is located in the open position, the fixing device being installable into the main housing from one side toward another side in an installation-removal direction and removable from the main housing from the another side toward the one side in the installation-removable direction, wherein
the cover overlaps the fixing device as viewed in the installation-removal direction and overlaps the fixing device as viewed in a widthwise direction perpendicular to the installation-removal direction and to an up-down direction, in a state where the fixing device is installed in the main housing and the cover is located in the closed position.

20. The image forming apparatus according to claim 19, wherein
the fixing device comprises a fixing handle graspable when the fixing device is installed into and removed from the main housing, the fixing handle being located at one end of the fixing device on one side in the widthwise direction, and
the cover is configured to cover the fixing handle from the one side in the widthwise direction in the state where the fixing device is installed in the main housing and the cover is located in the closed position.
